(19) United States
(12) Patent Application Publication
(10) Pub. No.: US 2026/0214429 A1
(43) Pub. Date: Jul. 23, 2026

(54) RADIO STATION, CORE NETWORK NODE, RADIO TERMINAL, AND METHODS

(71) Applicant: NEC Corporation, Tokyo (JP)

(72) Inventors: Toshiyuki TAMURA, Ibaraki (JP); Kundan TIWARI, Bengaluru (IN); Iskren IANEV, Reading (GB); Prabhu KALIYAMMAL THIRUVASAGAM, Kirchberg (LU)

(73) Assignee: NEC Corporation, Tokyo (JP)

(21) Appl. No.: 19/145,027

(22) PCT Filed: Dec. 27, 2023
(86) PCT No.: PCT/JP2023/046925

§ 371 Date: Jul. 1, 2025

(30) Foreign Application Priority Data
Jan. 13, 2023 (IN) 202311002701

(51) Int. Cl. H04W 4/90; H04W 4/02

(52) U.S. Cl. CPC H04W 4/90; H04W 4/025

(57) ABSTRACT

An aspect of this disclosure includes a radio station. A method for a radio station includes: communicating with a User Equipment (UE); and sending, to the UE, information indicating that the radio station offers service, wherein the UE is located in a disaster condition, wherein the UE is located in a 5G network, wherein the radio station is located in an Long Term Evolution (LTE) network.

### TECHNICAL FIELD

The present disclosure relates to a method of a radio station, a method of a core network node, a method of a radio terminal, a radio station, a core network node, and a radio terminal.

### BACKGROUND ART

According to the 3GPP (Third Generation Partnership Project) contribution SP-220938 (PTL 2), 3GPP defines two new service requirements to the Minimization of Service Interruption in the case of core network failure.

The following new service requirements are captured in the 3GPP TS 22.261 (PTL 6). The issue with the Visited Public Land Mobile Network (VPLMN) selection by the Internet of things (IOT) devices is summarized below.
Subject to regulatory requirements or operator's policy, in case of shared Radio Access Network (RAN) between participating PLMNs, the 3GPP system shall be able to support a UE of a given PLMN to obtain connectivity service (e.g., voice call, mobile data service) from another participating network when a Disaster Condition applies to the UE's PLMN.
Subject to regulatory requirements, operator's policy or UE capabilities, the 3GPP system shall be able to support a UE, with 5G-only national roaming access to a VPLMN, to obtain 4G connectivity service (e.g., voice call, mobile data service) from that VPLMN in the area where a Disaster Condition applies.

In order to comply with these requirements, 3GPP specifications need to be enhanced.

### CITATION LIST

### Non Patent Literature

NPL 1: 3GPP TR 21.905:“Vocabulary for 3GPP Specifications”. V17.1.0 (2021-12)
NPL 2: SP-220938: https://www.3gpp.org/ftp/tsg_sa/TSG_SA/TSGS_97E_Electronic_2022-09/Docs/SP-220938.zip
NPL 3: 3GPP TS 23.501: “System architecture for the 5G System (5GS)”. V18.0.0 (2022-12)
NPL 4: 3GPP TS 23.502: “Procedures for the 5G System (5GS)”. V18.0.0 (2022-12)
NPL 5: 3GPP TS 23.503: “Policy and charging control framework for the 5G System (5GS) Stage 2”. V18.0.0 (2022 -12)
NPL 6: 3GPP TS 22.261: “ Service requirements for the 5G system Stage 1”. V19.0.0 (2022 -09)
NPL 7: 3GPP TS 24.501: “Non-Access-Stratum (NAS) protocol for 5G System (5GS) Stage 3”. V18.1.0 (2022 -12)
NPL 8: 3GPP TS 38.413: “NG-RAN; NG Application Protocol (NGAP)”. V17.2.0 (2022-09)
NPL 9: 3GPP TS 38.331: “NR; Radio Resource Control (RRC) protocol specification”. V17.2.0 (2022-09)
NPL 10: 3GPP TS 23.401: “General Packet Radio Service (GPRS) enhancements for Evolved Universal Terrestrial Radio Access Network (E-UTRAN) access”. V17.6.0 (2022-09)
NPL 11: 3GPP TS 23.632: “User data interworking, coexistence and migration; Stage 2”. V 17.3.0 (2022 -09)
NPL 12: 3GPP TS 33.210: “Network Domain Security; IP network layer security”. V17.1.0 (2022-09)

### SUMMARY OF INVENTION

### Technical Problem

In 5G system, ensuring the availability of communication service is critical. 3GPP TS 22.261 (PTL 6) highlights the need for disaster mitigation services when a 5G system fails to serve its users due to RAN failure. 3GPP TS 22.261 (PTL 6) also specifies the requirements of disaster roaming where a user that is subject to Disaster Condition roams to another PLMN to resume connectivity and service. However, the requirements of supporting communication service under core network failure are not covered.

The following new service requirements to the disaster roaming need to be added to the 3GPP based mobile communication system in order to mitigate the 5G system service failures.
Subject to regulatory requirements or operator's policy, in case of shared RAN between participating PLMNs, the 3GPP system shall be able to support a UE of a given PLMN to obtain connectivity service (e.g., voice call, mobile data service) from another participating network when a Disaster Condition applies to the UE's PLMN.

### Solution to Problem

In a first example aspect, a radio station includes:
a memory; and
at least one processor configured to access the memory and configured to:
send, to a first core network node in a first network, a set up request message including information for a list of connected network,
receive, from the first core network node, a set up response message including at least one of information for a list of roaming networks and information for priority order for the roaming networks,
detect a failure of connection between the first core network node or another core network node in the first network; and
send, to a radio terminal, at least one of information related to disaster condition for the first network, information for the first network, information for the list of roaming networks and the information for priority order for the roaming networks.

In a second example aspect, a first core network node in a first network includes:
a memory; and
at least one processor configured to access the memory and configured to:
receive, from a radio station a set up request message including information for a list of connected network; and
send, to the radio station, a set up response message including at least one of information for a list of disaster roaming networks and information for priority order for the disaster roaming networks.

In a third example aspect, a radio terminal includes:
a memory; and
at least one processor configured to access the memory and configured to:
receive, from a radio station at least one of information related to disaster condition for the first network, information for a first network, information for a list of roaming networks and the information for priority order for the roaming networks; and
send, to a second core network node in the roaming network, a registration request message with a parameter used to initiate a disaster roaming service.

In a fourth example aspect, a method for a radio station includes:
means for sending, to a first core network node in a first network, a set up request message including information for a list of connected network,
means for receiving, from the first core network node, a set up response message including at least one of information for a list of roaming networks and information for priority order for the roaming networks,
means for detecting a failure of connection between the first core network node or another core network node in the first network; and
means for sending, to a radio terminal, at least one of information related to disaster condition for the first network, information for the first network, information for the list of roaming networks and the information for priority order for the roaming networks.

In a fifth example aspect, a method for a first core network node in a first network includes:
means for receiving, from a radio station a set up request message including information for a list of connected network; and
means for sending, to the radio station, a set up response message including at least one of information for a list of disaster roaming networks and information for priority order for the disaster roaming networks

In a sixth example aspect, a method for a radio terminal includes:
means for receiving, from a radio station at least one of information related to disaster condition for the first network, information for a first network, information for a list of roaming networks and the information for priority order for the roaming networks; and
means for sending, to a second core network node in the roaming network, a registration request message with a parameter used to initiate a disaster roaming service.

In a seventh example aspect, a first core network node in a first network includes:
a memory; and
at least one processor configured to access the memory and configured to:
receive, from a radio station a set up request message including information for a list of connected network; and
send, to the radio station a set up response message including at least one of information for a list of disaster roaming networks and information for priority order for the disaster roaming networks,
receive, from second core network node in the first network, information indicates minimization of service interruption is required,
send, to the radio station, information including at least one of new cause parameter, disaster condition indication parameter and available services parameter.

In an eighth example aspect, a method for a first core network node in a first network includes:
means for receiving, from a radio station a set up request message including information for a list of connected network; and
means for sending, to the radio station, a set up response message including at least one of information for a list of disaster roaming networks and information for priority order for the disaster roaming networks,
means for receiving, from second core network node in the first network, information indicates minimization of service interruption is required,
means for sending, to the radio station, information including at least one of new cause parameter, disaster condition indication parameter and available services parameter.

In a ninth example aspect, a radio terminal includes:
a memory; and
at least one processor configured to access the memory and configured to:
decide to perform a roaming service related to a disaster,
send, to a radio station, Radio Resource Control (RRC) setup request message including information indicates that the radio terminal has ability to support the roaming service related to the disaster,
receive, from the radio station, at least one of information related to disaster condition for a first network, information for the first network related to the disaster, information for a list of roaming networks and information for priority order for the roaming networks,
send, to the radio station, RRC setup complete message including at least one of information for the first network, the information indicates that the radio terminal has ability to support the roaming service related to disaster and the information related to disaster condition for the first network,
send, to the radio station, information related to the roaming network,
send, to the radio station, a Non Access Stratum (NAS) container information including registration request information including at least one of the information indicates that the radio terminal has ability to support the roaming service related to disaster and the information related to disaster condition for the first network.

In a tenth example aspect, a radio station includes:
a memory; and
at least one processor configured to access the memory and configured to:
receive, from a radio terminal, Radio Resource Control (RRC) setup request message including information indicates that the radio terminal has ability to support a roaming service related to a disaster,
send, to the radio terminal, at least one of information related to disaster condition for a first network, information for the first network related to the disaster, information for a list of roaming networks and information for priority order for the roaming networks,
receive, from the radio terminal, RRC setup complete message including at least one of information for the first network, the information indicates that the radio terminal has ability to support the roaming service related to disaster and the information related to disaster condition for the first network,
receive, from the radio terminal, information related to the roaming network,
receive, from the radio terminal, a Non Access Stratum (NAS) container information including registration request information including at least one of the information indicates that the radio terminal has ability to support the roaming service related to the disaster and the information related to disaster condition for the first network; and
send, to a third core network node in the roaming network (PLMN2), a registration request message including at least one of the information indicates that the radio terminal has ability to support the roaming service related to the disaster and the information related to disaster condition for the first network.

In an eleventh example aspect, a fourth core network node in a first network (PLMN1) related to a disaster includes:
a memory; and
at least one processor configured to access the memory and configured to:
receive, from a third core network node in a roaming network, a message including at least one of information indicates that a radio terminal has ability to support a roaming service related to the disaster and information related to disaster condition for the first network,
receive, from the third core network node, a message including at least one of the information indicates that the radio terminal has ability to support the roaming service related to the disaster and the information related to disaster condition for the first network; and
send, to the third core network node, a message including subscriber data.

In a twelfth example aspect, a third core network node in a second network includes:
a memory; and
at least one processor configured to access the memory and configured to:
receive, from a radio station, a registration request message including at least one of information indicates that a radio terminal has ability to support a roaming service related to a disaster and information related to disaster condition for a first network,
send, to a fourth core network node in a first network related to the disaster, a message including at least one of the information indicates that the radio terminal has ability to support the roaming service related to the disaster and the information related to disaster condition for the first network,
send, to the fourth core network node, a message including at least one of the information indicates that the radio terminal has ability to support the roaming service related to the disaster and the information related to disaster condition for the first network; and
receive, from the fourth core network node, a message including subscriber data.

In a thirteenth example aspect, a method for a radio terminal includes:
means for deciding to perform a roaming service related to a disaster,
means for sending, to a radio station, Radio Resource Control (RRC) setup request message including information indicates that the radio terminal has ability to support the roaming service related to the disaster,
means for receiving, from the radio station, at least one of information related to disaster condition for a first network, information for the first network related to the disaster, information for a list of roaming networks and information for priority order for the roaming networks,
means for sending, to the radio station, RRC setup complete message including at least one of information for the first network, the information indicates that the radio terminal has ability to support the roaming service related to disaster and the information related to disaster condition for the first network,
means for sending, to the radio station, information related to the roaming network,
means for sending, to the radio station, a Non Access Stratum (NAS) container information including registration request information including at least one of the information indicates that the radio terminal has ability to support the roaming service related to disaster and the information related to disaster condition for the first network.

In a fourteenth example aspect, a method for a radio station includes:
means for receiving, from a radio terminal, Radio Resource Control (RRC) setup request message including information indicates that the radio terminal has ability to support a roaming service related to a disaster
means for sending, to the radio terminal, at least one of information related to disaster condition for a first network, information for the first network related to the disaster, information for a list of roaming networks and information for priority order for the roaming networks,
means for receiving, from the radio terminal, RRC setup complete message including at least one of information for the first network, the information indicates that the radio terminal has ability to support the roaming service related to disaster and the information related to disaster condition for the first network,
means for receiving, from the radio terminal, information related to the roaming network,
means for receiving, from the radio terminal, a Non Access Stratum (NAS) container information including registration request information including at least one of the information indicates that the radio terminal has ability to support the roaming service related to the disaster and the information related to disaster condition for the first network; and
means for sending, to a third core network node in the roaming network, a registration request message including at least one of the information indicates that the radio terminal has ability to support the roaming service related to the disaster and the information related to disaster condition for the first network.

In a fifteenth example aspect, a method for a fourth core network node in a first network related to a disaster includes:
means for receiving, from a third core network node in a roaming network, a message including at least one of information indicates that a radio terminal has ability to support a roaming service related to the disaster and information related to disaster condition for the first network,
means for receiving, from the third core network node, a message including at least one of the information indicates that the radio terminal has ability to support the roaming service related to the disaster and the information related to disaster condition for the first network; and
means for sending, to the third core network node, a message including subscriber data.

In a sixteenth example aspect, a method for a third core network node in a second network includes:
means for receiving, from a radio station, a registration request message including at least one of information indicates that a radio terminal has ability to support a roaming service related to a disaster and information related to disaster condition for a first network,
means for sending, to a fourth core network node in a first network related to the disaster, a message including at least one of the information indicates that the radio terminal has ability to support the roaming service related to the disaster and the information related to disaster condition for the first network,
means for sending, to the fourth core network node, a message including at least one of the information indicates that the radio terminal has ability to support the roaming service related to the disaster and the information related to disaster condition for the first network; and
means for receiving, from the fourth core network node, a message including subscriber data.

In a seventeenth example aspect, a radio terminal includes:
a memory; and
at least one processor configured to access the memory and configured to:
decide to perform a roaming service related to a disaster,
send, to a radio station, Radio Resource Control (RRC) reestablishment request message including information indicates that the radio terminal has ability to support the roaming service related to the disaster,
receive, from the radio station, at least one of information related to disaster condition for a first network, information for the first network related to the disaster, information for a list of roaming networks and information for priority order for the roaming networks,
send, to the radio station, RRC setup complete message including at least one of information for the first network, the information indicates that the radio terminal has ability to support the roaming service related to disaster and the information related to disaster condition for the first network,
send, to the radio station, information related to the roaming network,
send, to the radio station, a Non Access Stratum (NAS) container information including registration request information including at least one of the information indicates that the radio terminal has ability to support the roaming service related to disaster and the information related to disaster condition for the first network.

In an eighteenth example aspect, a radio station includes:
a memory; and
at least one processor configured to access the memory and configured to:
receive, from a radio terminal, Radio Resource Control (RRC) reestablishment request message including information indicates that the radio terminal has ability to support a roaming service related to a disaster,
send, to the radio terminal, at least one of information related to disaster condition for a first network, information for the first network related to the disaster, information for a list of roaming networks and information for priority order for the roaming networks,
receive, from the radio terminal, RRC setup complete message including at least one of information for the first network, the information indicates that the radio terminal has ability to support the roaming service related to disaster and the information related to disaster condition for the first network,
receive, from the radio terminal, information related to the roaming network,
receive, from the radio terminal, a Non Access Stratum (NAS) container information including registration request information including at least one of the information indicates that the radio terminal has ability to support the roaming service related to the disaster and the information related to disaster condition for the first network; and
send, to a third core network node in the roaming network, a registration request message including at least one of the information indicates that the radio terminal has ability to support the roaming service related to the disaster and the information related to disaster condition for the first network.

In a nineteenth example aspect, a method for a radio terminal includes:
means for deciding to perform a roaming service related to a disaster,
means for sending, to a radio station, Radio Resource Control (RRC) reestablishment request message including information indicates that the radio terminal has ability to support the roaming service related to the disaster,
means for receiving, from the radio station, at least one of information related to disaster condition for a first network information for the first network related to the disaster, information for a list of roaming networks and information for priority order for the roaming networks,
means for sending, to the radio station, RRC setup complete message including at least one of information for the first network, the information indicates that the radio terminal has ability to support the roaming service related to disaster and the information related to disaster condition for the first network,
means for sending, to the radio station, information related to the roaming network,
means for sending, to the radio station, a Non Access Stratum (NAS) container information including registration request information including at least one of the information indicates that the radio terminal has ability to support the roaming service related to disaster and the information related to disaster condition for the first network.

In a twelfth example aspect, a method for a radio station includes:
means for receiving, from a radio terminal, Radio Resource Control (RRC) reestablishment request message including information indicates that the radio terminal has ability to support a roaming service related to a disaster,
means for sending, to the radio terminal, at least one of information related to disaster condition for a first network, information for the first network related to the disaster, information for a list of roaming networks and information for priority order for the roaming networks,
means for receiving, from the radio terminal, RRC setup complete message including at least one of information for the first network, the information indicates that the radio terminal has ability to support the roaming service related to disaster and the information related to disaster condition for the first network,
means for receiving, from the radio terminal, information related to the roaming network,
means for receiving, from the radio terminal, a Non Access Stratum (NAS) container information including registration request information including at least one of the information indicates that the radio terminal has ability to support the roaming service related to the disaster and the information related to disaster condition for the first network; and
means for sending, to a third core network node in the roaming network (PLMN2), a registration request message including at least one of the information indicates that the radio terminal has ability to support the roaming service related to the disaster and the information related to disaster condition for the first network.

### Advantageous Effects of Invention

According to the present disclosure, it is possible to provide a radio station, a core network node, a radio terminal, a method of a radio station, a method of a core network node, and a method of a radio terminal.

### BRIEF DESCRIPTION OF DRAWINGS

FIG. 1 is a signaling diagram of a First example of the First Aspect.

FIG. 2 is a signaling diagram of a Second example of the First Aspect.

FIG. 3 is a signaling diagram of a Third example of the First Aspect.

FIG. 4 is a signaling diagram of a Fourth example of the First Aspect.

FIG. 5 is a signaling diagram of a First example of the Second Aspect.

FIG. 6 is a data structure example in RRC message of a Second example of the Second Aspect.

FIG. 7 is a Subscriber data backup configuration of a Third example of the Second Aspect.

FIG. 8 is a relationship of Backup user identities of a Third example of the Second Aspect.

FIG. 9 is a signaling diagram of a Third example of the Second Aspect.

FIG. 10 is a signaling diagram of a Third example of the Second Aspect.

FIG. 11 is a signaling diagram of a Third example of the Second Aspect.

FIG. 12 is a signaling diagram of a Third example of the Second Aspect.

FIG. 13 is a diagram illustrating a system overview.

FIG. 14 is a block diagram illustrating a UE.

FIG. 15 is a block diagram illustrating an (R)AN node.

FIG. 16 is a diagram illustrating System overview of (R)AN node based on O-RAN architecture.

FIG. 17 is a block diagram illustrating an RU.

FIG. 18 is a block diagram illustrating a DU.

FIG. 19 is a block diagram illustrating a CU.

FIG. 20 is a block diagram illustrating an AMF.

FIG. 21 is a block diagram illustrating a PCF.

FIG. 22 is a block diagram illustrating an AUSF.

FIG. 23 is a block diagram illustrating a UDM.

FIG. 24 is a block diagram illustrating an NSSF.

### DESCRIPTION OF EMBODIMENTS

### Abbreviations

For the purposes of the present document, the abbreviations given in 3GPP TR 21.905 (PTL 1) and the following apply. An abbreviation defined in the present document takes precedence over the definition of the same abbreviation, if any, in 3GPP TR 21.905 (PTL 1).
4G-GUTI 4G Globally Unique Temporary UE Identity
5GC 5G Core Network
5GLAN 5G Local Area Network
5GS 5G System
5G-AN 5 G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function
ARFCN Absolute radio-frequency channel number
AS Access Stratum
ASN Abstract Syntax Notation
ATSSS Access Traffic Steering, Switching, Splitting
ATSSS-LL ATSSS Low-Layer
AuC Authentication Centre
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIS
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
HSS Home Subscriber Server
HTTP Hypertext Transfer Protocol
IAB Integrated access and backhaul
IPsec Internet Protocol Security
IMEI/TAC IMEI Type Allocation Code
IMSI International Mobile Subscriber Identity
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
ME Mobile Equipment
MFBR Maximum Flow Bit Rate
MICO Mobile Initiated Connection Only
MINT Minimization of service interruption
MITM Man In the Middle
MME Mobility Management Entity
MNC Mobile Network Code
MPS Multimedia Priority Service
MPTCP Multi-Path TCP Protocol
MT Mobile Termination
N3IWF Non-3GPP Inter Working Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NSAG Network Slice Access Stratum Group
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PCO Protocol Configuration Options
PCRF Policy and Charging Rules Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RRC Radio Resource Control
RSN Redundancy Sequence Number
RSRP Reference Signal Received Power
RSRQ Reference Signal Received Quality
SA NR Standalone New Radio
SBA Service Based Architecture
SBI Service Based Interface
SCP Service Communication Proxy
SD Slice Differentiator
SEAF Security Anchor Functionality
SENSE Signal Level Enhanced Network Selection
SEPP Security Edge Protection Proxy
SIB System Information Block
SINR Signal to Interference plus Noise Ratio
SMF Session Management Function
SMSF Short Message Service Function
SN Sequence Number
SN name Serving Network Name.
SNPN Stand-alone Non-Public Network
S-NSSAI Single Network Slice Selection Assistance Information
SOR Steering of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAI Tracking Area Identity (TAI)
TAU Tracking Area Update
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
UPSI UE Policy Section Identifier
URLLC Ultra Reliable Low Latency Communication
URRP-AMF UE Reachability Request Parameter for AMF
URSP UE Route Selection Policy
USIM User Services Identity Module
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in 3GPP TR 21.905 (PTL 1) and the following apply. A term defined in the present document takes precedence over the definition of the same term, if any, in 3GPP TR 21.905 (PTL 1).

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects (e.g., First Aspect, Second Aspect, Third Aspect, First example of the First Aspect, Second example of the First Aspect, Third example of the First Aspect, Fourth example of the First Aspect, First example of the Second Aspect, Second example of the Second Aspect, Third example of the Second Aspect, Variant of each Aspects) and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

Any lists described in following aspects include at least one parameter or multiple parameters.

An example object of this disclosure is to provide a method and apparatus that can solve the above problem.

### First Aspect

This aspect discloses a mechanism in the shared RAN environment that enables to move UEs, which have registered to a failed core network, to another participating PLMN that can provide the disaster roaming service as defined in 3GPP TS 23.501 (PTL 3).

### First Example of the First Aspect

When any connectivity services (e.g., voice call, mobile data service) cannot be provided by a PLMN due to core network failure, a shared RAN node indicates the failure in the PLMN to those UEs which are registered in the PLMN and triggers the disaster roaming service to another participating PLMN as defined in 3GPP TS 23.501 (PTL 3). This example discloses a mechanism of detecting a disaster condition in a PLMN.

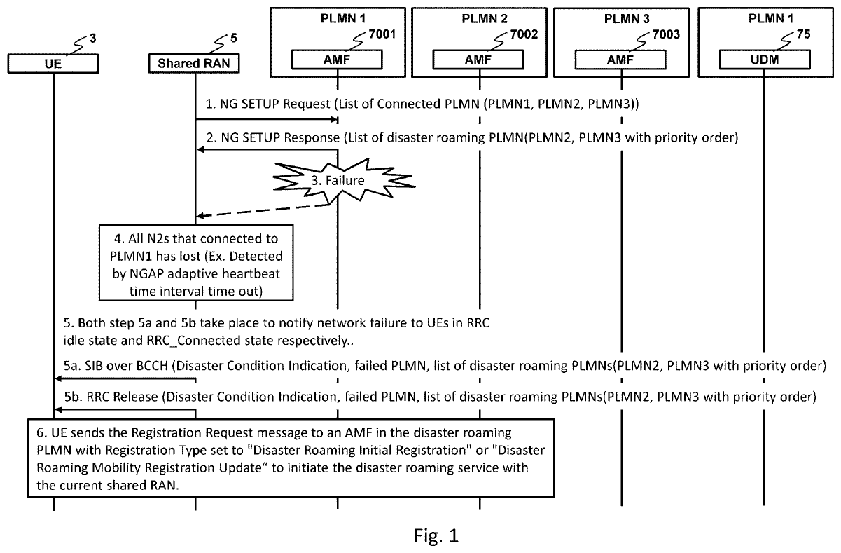

The detailed processes of the First example of the First Aspect are described below with reference to FIG. 1. FIG. 1 shows the scheme of triggering the registration procedure for disaster roaming (decision made by RAN).

Step 1. The Shared RAN 5 sends the NG SETUP Request message to the Access and Mobility Management Function (AMF) 7001 including a list of connected PLMNs (or any other notation for list of PLMNs which share the same RAN). The list of connected PLMNs includes all PLMNs that the Shared RAN 5 has at least one Next Generation Application Protocol (NGAP) association with an AMF which belongs to a PLMN which is included in the list of connected PLMNs provided by the Shared RAN 5.

In one example, the Shared RAN 5 includes in the list of connected PLMNs only PLMNs which have at least one NGAP association with a listed AMF and that PLMNs provide disaster roaming service with the PLMN 1 to which the AMF 7001 belongs to.

Step 2. Upon reception of the message in step 1, the AMF 7001 sends the NG SETUP Response message to the Shared RAN 5 including the list of disaster roaming PLMNs. The list of disaster roaming PLMNs includes all PLMNs that the PLMN 1 may have or may not have a service level agreement (SLA) for the disaster roaming service. The list of disaster roaming PLMN may have a priority information among the listed PLMNs. For example, the PLMNs are listed in decreasing order of priority, with the first PLMN being the highest priority PLMN. For example, the PLMNs are listed in increasing order of priority, with the last PLMN being the highest priority PLMN. For example, the disaster roaming PLMN is the PLMN which provides service if other PLMNs cannot provide the services or the PLMN which does not provide service if other PLMNs cannot provide the services.

In case where the shared RAN 5 has multiple Tracking Areas (TAS) configured, the list of disaster roaming PLMN is assigned on Tracking Area basis (I.e. TAC basis, or Tracking Area Code basis). For example, the list of disaster roaming PLMN may belong to the Supported TA Item parameter as defined in the 3GPP TS 38.413 (PTL 8).

Note that 3GPP TS 23.501 (PTL 3) defines that the Disaster Roaming service as follows.
The Disaster Roaming service is limited to the impacted geographic area with Disaster Condition. The NG-RAN nodes and AMF in the PLMN providing Disaster Roaming service are configured with the area information, i.e. a list of TAIs which can be formulated by the PLMN providing the Disaster Roaming service based on the geographic area with Disaster Condition in the other PLMN(s).

If multiple AMFs are deployed and connected to the shared RAN 5, the list of disaster roaming PLMN from the AMF 7001 can be effective for all AMFs in the PLMN 1. I.e., one AMF can represent the PLMN 1 and configure the list of disaster roaming PLMN in the shared RAN 1.

Step 3. The PLMN 1 encounters a network failure situation. Although the AMF 7001 is indicated as failure in step 3, this does not mean that only the AMF 7001 of the PLMN 1 has failed. The step 3 may indicate that some or the entire 5G Core Network (5GC) nodes failed or the underlying network for 5GC in PLMN 1 failed and any connectivity services (e.g., voice call, mobile data service) cannot be provided by the PLMN 1. For example, this failure may be detected by the Operation and Maintenance (OAM) system or any other monitoring function in the PLMN 1.

Step 4. The shared RAN 5 detects that any of connectivity services (e.g., voice call, mobile data service) cannot be provided by the PLMN 1 and decides to trigger the disaster roaming service with another participating PLMN (i.e. a PLMN which shares the same RAN node with PLMN 1). This detection can be one or combination of the following.
The shared RAN 5 receives an OAM message from the OAM system, any other monitoring function in the PLMN 1, or other network element (e.g., AMF) in the PLMN 1 indicating that PLMN 1 is encountering a network failure and the disaster roaming service is required. In one example, the shared RAN 5 receives a message from the OAM system, any other monitoring function in the PLMN or other network element (e.g., AMF) in the PLMN 1, indicating a network failure or the disaster roaming service is required.
All NGAP connections (i.e. N2 reference point) that connected from the Shared RAN to the AMFs in PLMN 1 have been lost. For example, loss of NGAP connection can be detected by a failure in the lower layer of the NGAP protocol or the NGAP adaptive heartbeat time interval time out.

Step 5. Once the shared RAN 5 decides to trigger the disaster roaming service with another participating PLMN, both steps, step 5a and step 5b take place. While the step 5a is referred by those UEs in an RRC Idle state and registered with the PLMN 1, the step 5b is a dedicated indication to the UE which is in the RRC connected state with the PLMN 1. I.e. Step 5b takes place for all UEs in the RRC connected state and registered with the PLMN 1.

Step 5a. The shared RAN 5 broadcasts new System Information Block (SIB) including Disaster Condition Indication, failed PLMN, and list of disaster roaming PLMN (PLMN2, PLMN3 with priority order). In one example, the new SIB is broadcast or sent over Broad Cast Control Channel (BCCH). In one example, the shared RAN 5 may broadcast or send new SIB including at least one of Disaster Condition Indication, information related to failed PLMN, and information related to PLMN which provides roaming in a case where other PLMN encounters a network failure situation. In one example, the failed PLMN may be information for PLMN 1 or information for PLMN which encounters a network failure situation. In one example, the Disaster Condition Indication parameter may indicate that the disaster roaming service is required as the PLMN 1 is encountering the disaster situation and is unable to provide connectivity services. In one example, the Disaster Condition Indication indicates damaged area, damaged time, damaged duration, damaged cause, damaged time etc . . . .

The combination of Disaster Condition Indication and failed PLMN indicates that a PLMN in the failed PLMN is in a disaster situation and all UEs which have been registered to the failed PLMN need to perform the registration procedure for disaster roaming service. In one example, the failed PLMN solely indicates that the PLMN is in the disaster situation and all UEs which have registered to the failed PLMN need to perform the registration procedure for disaster roaming service.

The list of disaster roaming PLMN indicates PLMNs that can provide the disaster roaming service. The list of disaster roaming PLMN may indicate PLMNs that provide roaming service in a case where other PLMN encounters a network failure situation. The list of disaster roaming PLMN may have a priority information among the listed PLMNs. For example, the PLMNs are listed in the order of decreasing priority, with the first PLMN being the highest priority PLMN. For example, the PLMNs are listed in the order of increasing priority, with the last PLMN being the highest priority PLMN.

In case where the Shared RAN 5 has multiple Tracking Area configured, the cell connected to the Shared RAN 5 broadcasts a list of disaster roaming PLMN in a new SIB which corresponds to the TAC of the cell in the received list of disaster roaming PLMN in step 2.

Step 5b. The shared RAN 5 sends RRC release message to those UEs which have an RRC connection to any AMFs belonging to the PLMN that are under the disaster condition (In this example PLMN 1).

The RRC release message includes Disaster Condition Indication, failed PLMN, list of disaster roaming PLMN (PLMN 2, PLMN 3 with priority order). Refer to Step 5a in this example for parameter details.

In addition, the RRC release message may include the redirectedCarrierInfo indicating a current cell that belongs to the shared RAN 5. This is an indication to the UE 3 not to reselect to any other cells as the current cell with the shared RAN 5 can provide the disaster roaming service to the UE 3.

Step 6. Once the UE 3 receives a message, either in step 5a or in step 5b, the UE 3 stays in the same cell and sends a Registration Request message to an AMF in the disaster roaming PLMN with Registration Type set to “Disaster Roaming Initial Registration” or “Disaster Roaming Mobility Registration Update” or any other notation for a new parameter with the purpose to initiate the disaster roaming service.

For detail procedure in step 6, refer to other examples in the First Aspect.

In one example, a radio station corresponds to the Shared RAN 5 sends, to a first core network node corresponds to AMF 7001 in a first network corresponds to PLMN1, a set up request message corresponds to NG SETPU Request including information for a list of connected network. The radio station receives, from the first core network node, a set up response message corresponds to NG_SETUP response including at least one of information for a list of roaming networks (e.g., information related to the PLMN 2 or PLMN 3) and information for priority order for the roaming networks (e. g., disaster roaming priority order etc). The radio station detects a failure of connection between the first core network node or another core network node in the first network. The radio station sends, to a radio terminal corresponding to UE, at least one of information related to disaster condition for the first network corresponds to Disaster Condition Indication, information for the first network (i.e., information related to the failed PLMN 1), information for the list of roaming networks (i.e., information related to PLMN2, PLMN3) and the information for priority order for the roaming networks (e.g., disaster roaming priority order). The information related to disaster condition for the first network (Disaster Condition Indication), the information for the first network (failed PLMN=1), the list of roaming networks (e.g., PLMN2, PLMN3) and the information for priority order for the roaming networks (e.g., disaster roaming priority order) may be included in a System Information Block (SIB) message in Step 5a or a Radio Resource Control Release message in Step 5b.

In one example, a first core network node corresponds to AMF 7001 in a first network corresponds to PLMN 1 receives, from a radio station corresponds to Shared RAN 5, a set up request message corresponds to NG SETPU Request including information for a list of connected network. The first core network node sends, to the radio station, a set up response message corresponds to NG_SETUP response including at least one of information for a list of disaster roaming networks (e.g. PLMN2, PLMN3) and information for priority order for the disaster roaming networks (e.g. disaster roaming priority order).

In one example, a radio terminal corresponds to UE receives, from a radio station corresponds to Shared RAN 5, at least one of information related to disaster condition for the first network corresponds to Disaster Condition Indication, information for a first network corresponds to information related to failed PLMN 1, information for a list of roaming networks (e.g. PLMN2, PLMN3) and the information for priority order for the roaming networks (e.g., disaster roaming priority order). The radio terminal sends, to a second core network node corresponds to AMF 7002 or AMF 7003 in the roaming network (e.g., PLMN2, PLMN 3), a registration request message with a parameter used to initiate a disaster roaming service (e.g., at least one of type information related to Disaster Roaming Initial Registration, Disaster Roaming Mobility Registration Update, and notation for a new parameter with the purpose to initiate the disaster roaming service).

### (Variant 1 of First Example of the First Aspect)

The step 1, the message initiated from the Shared RAN 5 to the AMF 7001 can be the RAN CONFIGURATION UPDATE message with the parameters as described in the step 1. The step 2, the message returned from AMF 7001 can be the RAN CONFIGURATION UPDATE ACKNOWLEDGE message with the parameters as described in the step 2.

### (Variant 2 of First Example of the First Aspect)

The list of disaster roaming PLMNs parameter as described in step 2 can be conveyed by the AMF CONFIGURATION UPDATE message which is initiated by the AMF 7001 towards the Shared RAN 5. The list of connected PLMN parameter as described in step 1 can be conveyed by the AMF CONFIGURATION UPDATE ACKNOWLEDGE message.

### (Variant 3 of First Example of the First Aspect)

In step 5b, the RRC Release message can be the RRC Reconfiguration message or any other new RRC message or existing RRC message.

### (Variant 4 of First Example of the First Aspect)

In step 5a, the shared RAN 5 broadcasts new SIB per Tracking Area Identity (TAI) or per cell gradually basis in order to avoid overload situation due to a massive number of Disaster Roaming service request.

Similarly in step 5b, the shared RAN 5 sends the RRC release message to those of UEs, UE by UE gradually, in order to avoid overload situation due to a massive number of Disaster Roaming service request.

### (Variant 5 of First Example of the First Aspect)

In one example, in step 6 the UE 3 triggers registration towards a PLMN supporting roaming in disaster only if the UE 3 is capable for roaming in disaster and the UE 3 has failed to register to the PLMN in disaster.

### (Variant 6 of First Example of the First Aspect)

In another example, at step 6 the UE 3 may not have knowledge which RAN 5 sharing PLMN provides roaming in disaster services, e.g. the roaming in disaster network capability is not broadcast in the SIB messages in step 5a or via the RRC Release message in step 5b. In this case a roaming in disaster capable UE 3 may include in the RRC message to RAN 5 during Registration at step 6 a new parameter called, for example ‘roaming in disaster’ parameter or any other notation for a parameter with the purpose to indicate to the RAN 5 that the UE 3 is requesting a connection for roaming in disaster. This new parameter ‘roaming in disaster’ may be included in one of the existing Access Stratum (AS) messages like RRC Connections Establishment Request or RRC Connection Establishment Complete message or in a new AS message. When the UE indicated the ‘roaming in disaster’ parameter in the AS message, the RAN 5 selects a sharing AMF from a PLMN which supports the roaming in disaster registration and services.

### (Variant 7 of First Example of the First Aspect)

In step 4, if the UE 3 is in RRC-Connected Inactive state, the Shared RAN 5 moves to the state RRC-IDLE when the Shared RAN 5 determines that the PLMN 1 has failed. In step 5, if the UE 3 is in RRC-Connected Inactive mode, the UE 3 moves to the RRC-IDLE mode and performs step 6.

### (Variant 8 of First Example of the First Aspect)

In one example, if the UE 3 is in the RRC-Connected state and the Shared RAN 5 in step 5 determines to steer the UE 3 to the highest priority PLMN (e.g. PLMN 2) from the disaster roaming PLMN list. The Shared RAN 5 allocates radio resources for the UE 3 and sends RRCreconfiguration message containing the radio resources (Signaling Radio bearer or Dedicated radio bearers) of PLMN 2 to the UE 3. In addition, the Shared RAN 5 includes the at least one of the parameters sent in step 5a or 5b and PLMN ID 2.

When the UE 3 receives RRCReconfiguration message with disaster roaming indication and PLMN 2 id 2, the UE 3 initiates registration procedure over the existing RRC connection to the PLMN 2.

### (Variant 8 of First Example of the First Aspect)

In one example, the UE3 is in the RRC-idle state, and the Shared RAN 5 receives RRCConnectionRequest message and the shared RAN 5 determines to steer the UE 3 to the highest priority PLMN (e.g. PLMN 2) from the disaster roaming PLMN list. The Shared RAN 5 allocates radio resources for the UE 3 and sends RRCSetup message containing the radio resources (Signaling Radio bearer or Dedicated radio bearers) of PLMN 2 to the UE 3. In addition, the Shared RAN 5 includes at least one of the parameters sent in step 5a or 5b and PLMN ID 2.

When the UE 3 receives RRCReconfiguration message with disaster roaming indication and PLMN 2 id 2, the UE 3 initiates registration procedure over the existing RRC connection to the PLMN 2.

### (Variant 9 of First Example of the First Aspect)

In step 2, PLMN 1 indicates the Disaster Condition Indication to the Shared RAN 5 to initiate UEs 3 to roam to another PLMN (e.g., PLMN 2) for resuming connectivity services under Disaster Roaming scenario. Multi Operator Core Network (MOCN) sharing scenario, based on the SLA, can be considered to save cost. In MOCN sharing scenario, PLMN 1 also indicates the Disaster Condition Indication to other MOCN PLMNs (e.g., PLMN2 and PLMN 3) using Internet Protocol security (IPsec) as described in 3GPP TS 33.210 (PTL 12) such that other MOCN PLMNs be prepared to provide services to UEs 3 of PLMN 1 under Disaster Roaming scenario.

### (Second Example of the First Aspect)

When any connectivity services (e.g., voice call, mobile data service) cannot be provided by a PLMN due to core network failure, a shared RAN node indicates the failure in the PLMN to those of UEs who are registered in the PLMN and triggers the disaster roaming service to another participating PLMN as defined in 3GPP TS 23.501 (PTL 3). This example discloses a mechanism of detecting a disaster condition in a PLMN.

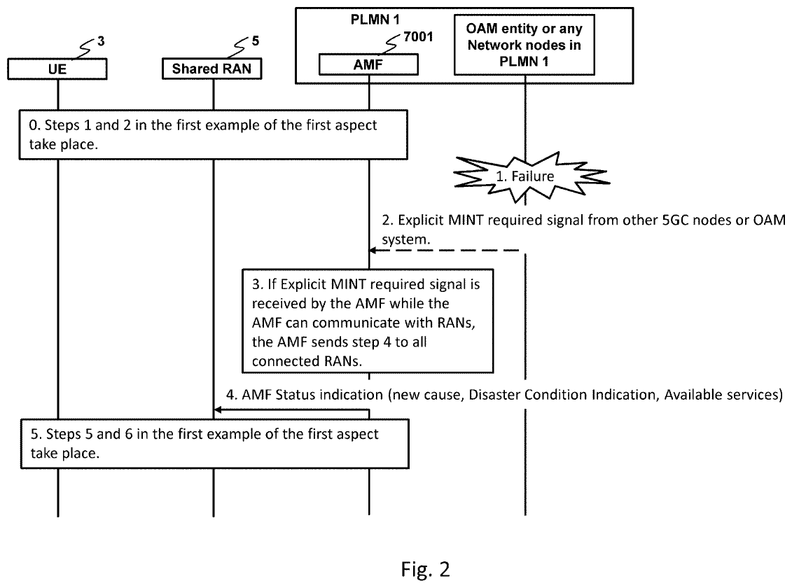

The detailed processes of the Second example of the First Aspect are described below, with reference to FIG. 2. FIG. 2 shows the scheme of triggering the registration procedure for disaster roaming (decision made by 5GC).

Step 0. Steps 1 and step 2 in the first example of the First Aspect take place.

Step 1. The PLMN 1 encounters the network failure and PLMN 1 decides to activate the disaster roaming service. In one example, a node in the PLMN 1 decides to activate the disaster roaming service. The node can be any of the core network nodes.

Step 2. Upon the decision for disaster roaming service activation in step 1, an entity in PLMN 1 sends a message to the AMF 7001 indicating that Minimization of service interruption (MINT) service (e.g., the disaster roaming service) is required. The entity can be any 5GC node or the OAM system in the PLMN 1. This message may include a parameter that indicates available services that the PLMN 1 can still provide. For example, all connectivity services are not available except Emergency call service.

Step 3. If the message in step 2 indicates the Disaster Condition Indication while the AMF 7001 can still communicate with Shared RAN 5, the AMF 7001 proceeds with step 4 and following steps for all connected RANs.

Step 4. The AMF 7001 sends the AMF Status indication message to the Shared RAN 5 including new cause, Disaster Condition Indication and Available services. The new cause parameter may indicate that this message is related to the disaster roaming service. The Disaster Condition Indication parameter may indicate that the disaster roaming service is required as the PLMN 1 is encountering the disaster situation and is unable to provide connectivity services. The Available services may be a parameter that is copied from the Available services parameter in step 2. This information related to the Available services may include a parameter that indicates available services that the PLMN 1 can still provide. For example, all connectivity services are not available except Emergency call service.

Step 5. Step 5 and step 6 from the first example of the First Aspect take place.

In addition, the messages in step 5a and step 5b of the first example of the First Aspect may include the Available services parameter. The Available services parameter can be referred by the UE 3 whether the UE 3 stays in the PLMN 1 to use the services indicated in the Available services parameter. For example, if the Available services parameter indicates Emergency service, the UE 3 can have the Emergency services with PLMN 1. If the UE 3 initiates the Emergency service, the Shared RAN 5 only accepts an RRC establishment message from the UE 3 if the RRC establishment cause is Emergency.

In one example, a first core network node corresponds to AMF 7001 in a first network corresponds to PLMN receives, from a radio station corresponds to Shared RAN 5, a set up request message corresponds to NG SETPU Request including information for a list of connected network. The first core network node sends, to the radio station, a set up response message corresponds to NG_SETUP response including at least one of information for a list of disaster roaming networks (e. g., PLMN2, PLMN3) and information for priority order for the disaster roaming networks (e.g., disaster roaming priority order). The first core network node receives, from a second core network node in the first network corresponds to OAM entity or any network node in PLMN 1, information indicates minimization of service interruption is required (e.g., MINT required signal). The first core network node sends, to the radio station, information including at least one of new cause parameter, disaster condition indication parameter and available services parameter.

### (Variant 1 of Second Example of the First Aspect)

In step 4, the AMF 7001 Status indication message can be another NGAP message. For example, it can be one of the AMF CONFIGURATION UPDATE message, NG RESET message, ERROR INDICATION message, OVERLOAD START message or an existing NGAP message or a new NGAP message.

### (Third Example of the First Aspect)

When the UE 3 is in RRC_Idle state and the UE 3 recognizes that the PLMN 1 is encountering the network failure. Then the UE 3 may decide to perform the disaster roaming service to another participating PLMN.

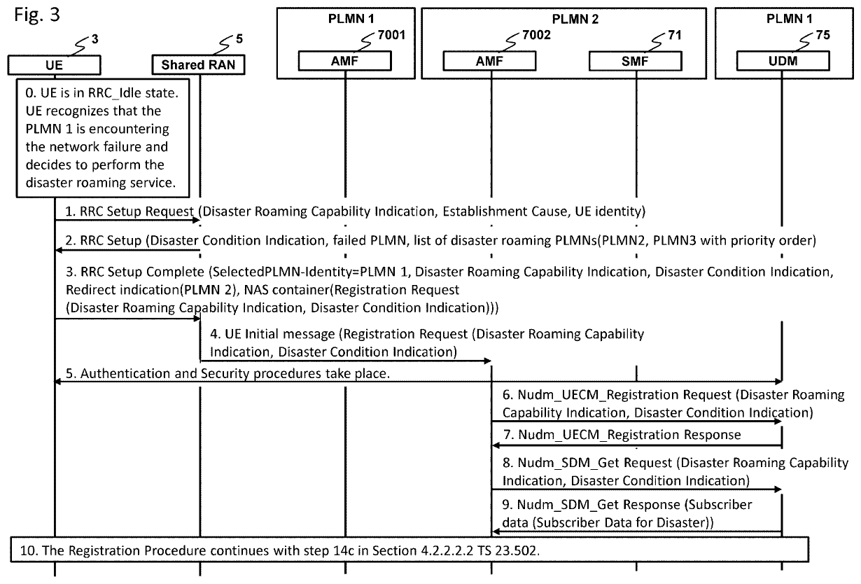

The detailed processes of the Third example of the First Aspect are described below with reference to FIG. 3. FIG. 3 shows the scheme of the disaster roaming service initiation when the UE is in RRC Idle state.

Step 0. When the UE 3 is in RRC_Idle state and the UE 3 recognizes that the PLMN 1 is encountering the network failure. Then the UE 3 may decide to perform the disaster roaming service to another participating PLMN. One example, the UE 3 decides to perform the disaster roaming service when the UE 3 receives the SIB information as described in step 5a in the first example of the First Aspect. Another example, the UE 3 decided to perform the disaster roaming service when the UE 3 receives the RRC Release message as described in step 5b in the first example of the First Aspect.

Step 1. The UE 3 sends the RRC Setup Request message to the Shared RAN 5 including Establishment Cause, UE identity and Disaster Roaming Capability Indication. The UE identity indicates an identity of the UE 3. The UE identity may take a form of 5G-S-TMSI. The Disaster Roaming Capability Indication indicates that the UE 3 has an ability to support the Disaster Roaming service. In one example, The Disaster Roaming Capability Indication indicates that the UE 3 has an ability to support the Disaster Roaming service in AS layer. I.e., Between UE 3 and Shared RAN 5.

In another example, The Disaster Roaming Capability Indication indicates that the UE 3 has an ability to support the Disaster Roaming service in both AS layer and Non-Access-Stratum (NAS) layer. I.e., Between UE 3 and Shared RAN 5 and Between UE 3 and AMF.

Step 2. Upon the reception of the RRC Setup Request message in step 1, the Shared RAN 5 sends the RRC Setup Request message to the UE 3 including Disaster Condition Indication, failed PLMN, list of disaster roaming PLMN (PLMN 2 in this example). Refer to Step 5a in the first example of the First Aspect for parameter details.

Step 3. The UE 3 sends the RRC Setup Complete message including SelectedPLMN-Identity=PLMN 1, Disaster Roaming Capability Indication, Disaster Condition Indication, Redirect indication, and NAS container. The Selected PLMN-Identity indicates the PLMN 1 as the UE has been registered to the PLMN 1 and a 5G-S-TMSI or a UE identity has been assigned by the PLMN 1. For the Disaster Roaming Capability Indication, refer to Step 1 for details of the Disaster Roaming Capability Indication. The Disaster Roaming Capability may not be set it again by the UE 3 if this indication is set on the RRC Setup Request message in step 1. The Disaster Condition Indication indicates that the associated PLMN (PLMN 1 in this example) as indicated by the Selected PLMN-Identity has been encountering the disaster condition and unable to provide any connectivity services (e.g., voice call, mobile data service). The Redirect indication includes an PLMN that the UE 3 requests to be redirected to as the Disaster Roaming service. (PLMN 2 in this example).

The NAS container includes the Registration Request message. The Registration Request message includes Disaster Roaming Capability Indication and/or Disaster Condition Indication. The Disaster Roaming Capability Indication indicates to the AMF that the UE 3 has an ability to support the Disaster Roaming service in NAS layer. I.e., Between UE 3 and AMF. The Disaster Condition Indication indicates that the associated PLMN (PLMN 1 in this example) has been encountering the disaster condition and may not be able to provide any connectivity services (e.g., voice call, mobile data service).

In case that the UE 3 does not perform Disaster Roaming Service, the UE 3 may perform another action, for example PLMN selection.

Step 4. The Shared RAN 5 sends the UE Initial message to the AMF 7002 in the PLMN 2 including Registration Request message in case where the Shared RAN 5 decides to perform the Disaster Roaming service with the PLMN 2. The registration Request message includes Disaster Roaming Capability Indication and Disaster Condition Indication. In one example, for the Disaster Roaming Capability Indication, refer to Step3 for details of the Disaster Roaming Capability Indication. In one example, for the Disaster Condition Indication, refer to Step 2, Step 3 for details of the Disaster Condition Indication.

The Shared RAN 5 may decide to perform the Disaster Roaming service with the PLMN 2 if at least one of the following condition matches.
In the RRC Setup Complete message, the UE 3 indicates that the Disaster Roaming Capability Indication=Supported, Disaster Condition Indication and the Redirect indication=PLMN 2.
In the RRC Setup Complete message, the UE 3 indicates that the Disaster Roaming Capability Indication=Supported, Disaster Condition Indication and the SelectedPLMN-Identity=PLMN 1. Then the Share RAN 5 decides to redirect to the UE 3 to the PLMN 2 based on an internal data in the Shared RAN 5. For example, the internal data in the Shared RAN 5 may be constructed by the step 4 in the first example of the First Aspect and the PLMN 2 is listed as the highest priority among candidate PLMNs. For another example, the internal data in the Shared RAN 5 may be constructed when the Shared RAN 5 receives the message as described in the step 4 in the second example of the First Aspect and the PLMN 2 is listed as the highest priority among candidate PLMNs.

Step 5. When the AMF 7002 receives the Registration Request message from the UE 3 via a RAN, the Authentication and Security procedures take place with the Disaster Roaming service into account as described in section 4.2.2.2.2 in 3GPP TS 23.502 (PTL 4).

Step 6. The AMF 7002 sends the Nudm_UECM_Registration Request message to a Unified Data Management (UDM) 75 in the PLMN 1 including Disaster Roaming Capability Indication and Disaster Condition Indication as received in the Registration Request message in Step 4. For example, the UDM 75 may not belong to the PLMN 1 in case where the UE 3 is an inbound roamer to the PLMN 1.

Step 7. Upon reception of the Nudm_UECM_Registration Request message in step 6, the UDM 75 sends the Nudm_UECM_Registration Response message to the AMF 7002. As the Disaster Condition Indication is indicated in the Nudm_UECM_Registration Request message, the UDM 75 registers the AMF 7002 as the roaming node even there is no roaming agreement established with the PLMN 2.

Step 8. The AMF 7002 sends the Nudm_SDM_Get Request message to the UDM 75 in PLMN 1 including Disaster Roaming Capability Indication and Disaster Condition Indication as received in the Registration Request message in Step 4.

Step 9. Upon reception of the Nudm_SDM_Get Request message in step 8, the UDM 75 sends the Nudm_UECM_Registration Response message including a Subscriber Data for Disaster to the AMF 7002. The UDM 75 provides the dedicated Subscriber Data to the AMF 7002 even there is no roaming agreement established with the PLMN 2 because of the Disaster Condition Indication is indicated in the Nudm_SDM_Get Request message.

The UDM 75 may provide a full set of Subscriber Data to the AMF 7002 even there is no roaming agreement established with the PLMN 2 because of the Disaster Condition Indication is indicated in the Nudm_SDM_Get Request message based on operator configuration or/and roaming agreements.

Step 10. The Registration procedure continues with step 14c in section 4.2.2.2.2 in 3GPP TS 23.502 (PTL 4).

In one example, a radio terminal corresponds to UE) decides to perform a roaming service related to a disaster. The radio terminal sends, to a radio station corresponds to Shared RAN 5, Radio Resource Control (RRC) setup request message including information indicates that the radio terminal has ability to support the roaming service related to the disaster corresponds to Disaster Roaming Capability Indication). The radio terminal receives, from the radio station, at least one of information related to disaster condition for a first network corresponds to Disaster Condition Indication, information for the first network corresponds to information related to failed PLMN 1 related to the disaster, information for a list of roaming networks (e. g., PLMN 2, PLMN 3) and information for priority order for the roaming networks (e.g., disaster roaming priority order). The radio terminal sends, to the radio station, RRC setup complete message including at least one of information for the first network (e.g., selected PLMN-Identity PLMN 1), the information indicates that the radio terminal has ability to support the roaming service related to disaster corresponds to Disaster Roaming Capability Indication) and the information related to disaster condition for the first network corresponds to Disaster Condition Indication. The radio terminal sends, to the radio station, information related to the roaming network (e.g., Redirect indication related to PLMN 2). The radio terminal sends, to the radio station, a Non-Access Stratum (NAS) container information (e.g. NAS container) including registration request information including at least one of the information indicates that the radio terminal has ability to support the roaming service related to disaster corresponds to Disaster Roaming Capability Indication) and the information related to disaster condition for the first network corresponds to Disaster Condition Indication.

In one example, a radio station corresponds to Shared RAN 5 receives, from a radio terminal corresponds to UE, Radio Resource Control (RRC) setup request message including information indicates that the radio terminal has ability to support a roaming service related to a disaster corresponds to Disaster Roaming Capability Indication. The radio station sends, to the radio terminal, at least one of information related to disaster condition for a first network corresponds to Disaster Condition Indication, information for the first network (e.g., information related to failed PLMN1) related to the disaster, information for a list of roaming networks (e.g., PLMN 2, PLMN 3) and information for priority order for the roaming networks (e.g., disaster roaming priority order). The radio station receives, from the radio terminal, RRC setup complete message including at least one of information for the first network (e.g., information for selected PLMN-Identity related to PLMN 1), the information indicates that the radio terminal has ability to support the roaming service related to disaster corresponds to Disaster Roaming Capability Indication and the information related to disaster condition for the first network corresponds to Disaster Condition Indication. The radio station receives, from the radio terminal, information related to the roaming network (Redirect indication (PLMN2)). The radio station receives, from the radio terminal, a Non-Access Stratum (NAS) container information (e.g., NAS container) including registration request information including at least one of the information indicates that the radio terminal has ability to support the roaming service related to the disaster corresponds to Disaster Roaming Capability Indication and the information related to disaster condition for the first network corresponds to Disaster Condition Indication. The radio station sends, to a third core network node corresponds to AMF 7002 in the roaming network corresponds to PLMN 2, a registration request message including at least one of the information indicates that the radio terminal has ability to support the roaming service related to the disaster corresponds to Disaster Roaming Capability Indication and the information related to disaster condition for the first network corresponds to Disaster Condition Indication.

In one example, a fourth core network node corresponds to UDM 75 in a first network corresponds to PLMN 1 related to a disaster receives, from a third core network node corresponds to AMF 7002 in a roaming network corresponds to PLMN 2, a message including at least one of information indicates that a radio terminal has ability to support a roaming service related to the disaster corresponds to Disaster Roaming Capability Indication) and information related to disaster condition for the first network corresponds to Disaster Condition Indication). The fourth core network node receives, from the third core network node, a message including at least one of the information indicates that the radio terminal has ability to support the roaming service related to the disaster corresponds to Disaster Roaming Capability Indication and the information related to disaster condition for the first network corresponds to Disaster Condition Indication). The fourth core network node sends, to the third core network node, a message including subscriber data.

In one example, a third core network node corresponds to AMF 7002 in a second network corresponds to PLMN 2 receives, from a radio station corresponds to Shared RAN 5, a registration request message including at least one of information indicates that a radio terminal has ability to support a roaming service related to a disaster corresponds to Disaster Roaming Capability Indication) and information related to disaster condition for a first network corresponds to Disaster Condition Indication. The third core network node sends, to a fourth core network node corresponds to UDM 75 in a first network PLMN 1 related to the disaster, a message including at least one of the information indicates that the radio terminal has ability to support the roaming service related to the disaster corresponds to Disaster Roaming Capability Indication and the information related to disaster condition for the first network corresponds to Disaster Condition Indication. The third core network node sends, to the, a message including at least one of the information indicates that the radio terminal has ability to support the roaming service related to the disaster (e.g., Disaster Roaming Capability Indication) and the information related to disaster condition for the first network (e.g., Disaster Condition Indication). The third core network node receives, from the fourth core network node (UDM75 in PLMN1), a message including subscriber data.

### (Variant 1 of Third Example of the First Aspect)

In step 1, the RRC Setup Request message can be an RRC Reconfiguration Request message or any other new RRC message or existing RRC message.

Similarly, in step 2, the RRC Setup message can be an RRC Reconfiguration message or any other new RRC message or existing RRC message.

Similarly, in step 3, the RRC Setup Complete message can be an RRC Reconfiguration Complete message or any other new RRC message or existing RRC message.

### (Variant 2 of Third Example of the First Aspect)

In step 4, the Shared RAN 5 may send the UE Initial message to an AMF in another PLMN in case where the AMFs in the PLMN 2, the highest priority among candidate PLMNs, are all under overload condition.

### (Variant 3 of Third Example of the First Aspect)

In step 0, one example of how the UE 3 in idle mode registered with PLMN1 finds out that the PLMN 1 is in disaster condition is via the System Information Broadcast. The UE 3 in idle mode regularly reads the SI messages broadcast by the Shared RAN 5. If the UE is registered with PLMN 1 and PLMN 1 enters into a disaster condition, this can be indicated by AMF 7001 to the Shared RAN 5 as per step 4 in FIG. 2. Then the Shared RAN 5 may broadcast the disaster condition for PLMN 1 in one of the SI messages in a new parameter called ‘PLMN in disaster’ or any other notation for a parameter to indicate the PLMN in disaster. Then the UE 3 may follow steps 1 to 10 in FIG. 3 in order to register with another sharing PLMN which provides roaming in disaster services.

### (Fourth Example of the First Aspect)

When the UE 3 is in RRC_Connected state and the UE 3 recognizes that the PLMN 1 is encountering the network failure, then the UE 3 may decide to perform the disaster roaming service to another participating PLMN.

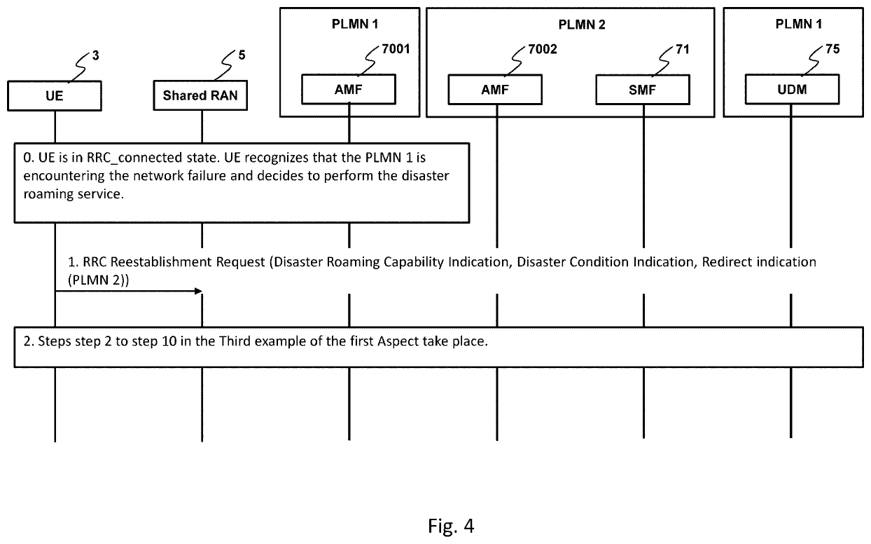

The detailed processes of the Fourth example of the First Aspect are described below, with reference to FIG. 4. FIG. 4 shows the scheme of the disaster roaming service initiation when the UE is in RRC Connected state. This call flow can be referred as an enhancement on the RRC re-establishment, fallback to RRC establishment procedure as described in section 5.3.7.1 in 3GPP TS 38.331 (PTL 9).

Step 0. When the UE 3 is in RRC Connected state and the UE 3 recognizes that the PLMN 1 is encountering the network failure, then the UE 3 may decide to perform the disaster roaming service to another participating PLMN. In one example, the UE 3 decides to perform the disaster roaming service when the UE 3 receives the SIB information as described in step 5a in the first example of the First Aspect.

Another example, the UE 3 decided to perform the disaster roaming service when the UE 3 receives the RRC Release message as described in step 5b in the first example of the First Aspect.

Step 1. The UE 3 sends the RRC Re-establishment message to the Shared RAN 5 including Disaster Roaming Capability Indication, Disaster Condition Indication, Redirect indication.

Refer to step 3 in the third example of the First Aspect for parameter details.

Step 2. Step 2 to step 10 in the third example of the First Aspect take place.

In one example, a radio terminal corresponds to UE decides to perform a roaming service related to a disaster. The radio terminal send, to a radio station corresponds to Shared RAN 5, Radio Resource Control (RRC) reestablishment request message including information indicates that the radio terminal has ability to support the roaming service related to the disaster corresponds to Disaster Roaming Capability Indication). The radio terminal receives, from the radio station, at least one of information related to disaster condition for a first network corresponds to Disaster Condition Indication, information for the first network (e.g., information related to failed PLMN1 related to the disaster, information for a list of roaming networks (e.g., PLMN 2, PLMN 3) and information for priority order for the roaming networks (e.g., disaster roaming priority order). The radio terminal sends, to the radio station, RRC setup complete message including at least one of information for the first network (e.g., information related to selected PLMN-Identity related to PLMN 1), the information indicates that the radio terminal has ability to support the roaming service related to disaster (e.g., Disaster Roaming Capability Indication) and the information related to disaster condition for the first network (e.g., Disaster Condition Indication. The radio terminal sends, to the radio station, information related to the roaming network corresponds to Redirect indication related to PLMN 2. The radio terminal sends, to the radio station, a Non-Access Stratum (NAS) container information (e.g., NAS container) including registration request information including at least one of the information indicates that the radio terminal has ability to support the roaming service related to disaster (e.g., Disaster Roaming Capability Indication) and the information related to disaster condition for the first network (e.g., Disaster Condition Indication).

In one example, a radio station corresponds to Shared RAN 5 receives, from a radio terminal corresponds to UE, Radio Resource Control (RRC) reestablishment request message including information indicates that the radio terminal has ability to support a roaming service related to a disaster corresponds to Disaster Roaming Capability Indication). The radio station send, to the radio terminal, at least one of information related to disaster condition for a first network corresponds to Disaster Condition Indication, information for the first network (e.g., information related to failed PLMN 1) related to the disaster, information for a list of roaming networks (e. g., PLMN 2, PLMN 3) and information for priority order for the roaming networks (e. g., disaster roaming priority order). The radio station receives, from the radio terminal, RRC setup complete message including at least one of information for the first network (e.g., information related to failed PLMN 1), the information indicates that the radio terminal has ability to support the roaming service related to disaster (e.g., Disaster Roaming Capability Indication) and the information related to disaster condition for the first network (e.g., Disaster Condition Indication). The radio station receives, from the radio terminal, information related to the roaming network corresponds to Redirect indication related to PLMN2. The radio station receives, from the radio terminal, a Non-Access Stratum (NAS) container information (e.g., NAS container) including registration request information including at least one of the information indicates that the radio terminal has ability to support the roaming service related to the disaster (e.g., Disaster Roaming Capability Indication) and the information related to disaster condition for the first network (e.g., Disaster Condition Indication). The radio station sends, to a third core network node corresponds to AMF 7002 in the roaming network corresponds to PLMN2, a registration request message including at least one of the information indicates that the radio terminal has ability to support the roaming service related to the disaster (e.g., Disaster Roaming Capability Indication) and the information related to disaster condition for the first network (e.g., Disaster Condition Indication).

### (Second Aspect)

This aspect discloses a mechanism to 5G-only national roaming users to allow to access to connectivity services (e.g., voice call, mobile data service) that is provided by the 4G (EPS system) in the VPLMN in case the disaster situation is encountered in the 5G network.

### (First Example of the Second Aspect)

The PLMN 1 provides 5G services to the 5G only UE. I.e., the 5G only UE means that the UEs who are allowed 5G-only national roaming access to a VPLMN. For example, some countries restrict national roaming between Evolved Packet System (EPS)s because all PLMN operators cover entire nation of the country while 5G coverage is not fully achieved and for this reason national roaming in 5G may be allowed in some countries.

In case 5G System (5GS) fails and encounters a disaster situation, the 5G only UE in the 5GS is permitted to perform the Disaster Roaming service with EPS access only if the 5G only UE loses any connectivity service (e.g., voice call, mobile data service) over 5GS.

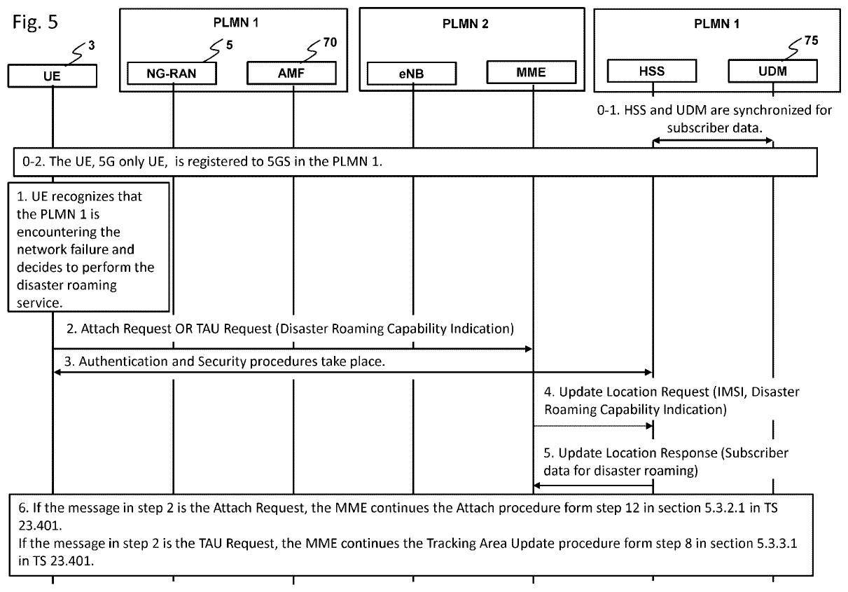

The detailed processes of the First example of the Second Aspect are described below, with reference to FIG. 5. FIG. 5 shows the scheme of the disaster roaming service to EPS for 5G only UE.

Step 0-1. In PLMN 1, some or all subscriber data are synchronized between the Home Subscriber Sever (HSS) and the Unified Data Management (UDM) 75. One example, the HSS and the UDM 75 is synchronized using the NU1 reference point as defined in 3GPP TS 23.632 (PTL 11).

Step 0-2. The PLMN 1 provides 5G services to the 5G only UE. The 5G only UE may be restricted to access EPS for example by 1) Access restriction data set to access to EPS not allowed in the subscription data in UDM/HSS or 2) Roaming not allowed to EPS part of VPLMNs in the subscription data in UDM/HSS or 3) UE does not have a valid EPS subscription data in the HSS.

Step 1. The UE 3 recognizes that the PLMN 1 is encountering the network failure. Then the UE 3 may decide to perform the disaster roaming service to another PLMN including EPS network. In one example, the UE 3 decides to perform the disaster roaming service to the EPS network when the UE 3 receives the SIB information as described in step 5a in the first example of the First Aspect. The list of disaster roaming PLMNs in step 5a in the first example of the First Aspect may have an indication support of EPS to each listed PLMN.

In another example, the UE 3 decides to perform the disaster roaming service to the EPS network when the UE 3 receives the RRC Release message as described in step 5b in the first example of the First Aspect. The list of disaster roaming PLMNs in step 5b in the first example of the First Aspect may have an indication support of EPS to each listed PLMN.

Step 2. The UE 3 sends an Attach request message to a Mobility Management Entity (MME) in PLMN 2 via an eNodeB in PLMN 2 including Disaster Roaming Capability Indication. Refer to step 3 in the third example of the First Aspect for parameter details. In one example, the Attach request message may be a Tracking Area Update (TAU) request message.

Step 3. When the MME receives the Attached request message from the UE 3, the Authentication and Security procedures may take place.

Step 4. The MME sends the Update Location Request message to the HSS in PLMN 1 including International Mobile Subscriber Identity (IMSI), Disaster Roaming Capability Indication as received in the Attach request message or TAU request message in Step 2.

Step 5. Upon reception of the Update Location Request message in step 4, the HSS sends the Location Response message to the MME including a Subscriber data for disaster roaming. The HSS provides the dedicated Subscriber Data to the MME if the following condition matches.
The Disaster Condition Indication is indicated in Update Location Request message while there is no roaming agreement established with the PLMN 2.
The Disaster Condition Indication is indicated in Update Location Request message while PLMN 2 is registered as “roaming not allowed” in the subscriber data for the UE 3.
The Disaster Condition Indication is indicated in Update Location Request message while there is no subscriber data for the EPS access but for the 5GS access. In this case, the HSS generates a Subscriber Data for Disaster for EPS based on the subscriber data for 5GS.

Step 6. Upon reception of the Location Response message, the MME continues the attach procedure with step 12 in section 5.3.2.1 in 3GPP TS 23.401 (PTL 10).

If the message in step 2 is the TAU request message, the MME continues the Tracking Area Update procedure with step 8 in section 5.3.3.1 in 3GPP TS 23.401 (PTL 10).

In case that the received Subscriber Data for Disaster from the HSS in step 5 has the Access Restriction Data set as “E-UTRAN not allowed”, the MME ignores this data and continues the attach procedure or the Tracking Area Update procedure exceptionally as it is the Disaster Roaming service.

In one example, a radio terminal corresponds to UE in 5G network decides to perform a roaming service related to a disaster. The radio terminal sends, to a fifth core network node corresponds to MME in PLMN2 in 4G network, information indicates that the radio terminal has ability to support the roaming service related to the disaster corresponds to Disaster Roaming Capability Indication.

In one example, a sixth core network node corresponds to HSS in PLMN 1 in 5G network receives, from a fifth core network node corresponds to MME in PLMN 2 in 4G network, information indicates that the radio terminal has ability to support the roaming service related to the disaster corresponds to Disaster Roaming Capability Indication. The sixth core network node send, to the fifth core network node subscriber data.

(Variant 1 of First example of the Second Aspect)

In case where the disaster condition was fixed and the 5G service over PLMN 1 becomes available, this recovery information shall be provided to the HSS. Then the HSS initiates the HSS-initiated Detach procedure as described in section 5.3.8.4 in 3GPP TS 23.401 (PTL 10). In this case, the Cancel Location message from the HSS to the MME may include “Back to 5G” parameter indicating that the Disaster Roaming service over EPS for 5G only UE cannot be justified anymore. When the MME receives the “Back to 5G” parameter in the Cancel Location message, the MME sends the Detach Request message to the UE 3 including “Back to 5G” parameter indicating the UE 3 that the 5GS service is available and may go back to the 5GS.

### (Variant 2 of First Example of the Second Aspect)

In case where the disaster condition was fixed and the 5G service over PLMN 1 becomes available, this recovery information shall be provided to the MME. Then the MME initiates the MME-initiated Detach procedure as described in section 5.3.8.3 in 3GPP TS 23.401 (PTL 10). In this case, the MME sends the Detach Request message to the UE 3 including “Back to 5G” parameter indicating the UE 3 that the 5GS service is available and may go back to the 5GS.

### (Variant 3 of First Example of the Second Aspect)

In case where the disaster condition was fixed and the 5G service over PLMN 1 becomes available, this recovery information shall be provided to the MME. Then the MME may initiate the EPS to 5GS Mobility Registration Procedure (Idle and Connected State) using N26 interface as described in section 4.11.1.3.3 in 3GPP TS 23.502 (PTL 4).

### (Variant 4 of First Example of the Second Aspect)

In case where the disaster condition was fixed and the 5G service over PLMN 1 becomes available, this recovery information shall be provided to the MME. Then the MME may initiate the EPS to 5GS Idle mode mobility using N26 interface with data forwarding as described in section 4.11.1.3.3A in 3GPP TS 23.502 (PTL 4).

### (Variant 5 of First Example of the Second Aspect)

In case where the disaster condition was fixed and the 5G service over PLMN 1 becomes available, this recovery information shall be provided to the MME. Then the MME may initiate the EPS to 5GS Mobility Registration Procedure (Idle) using N26 interface with AMF reallocation as described in section 4.11.1.3.4 in 3GPP TS 23.502 (PTL 4).

### (Variant 6 of First Example of the Second Aspect)

In one example, a Home Public Land Mobile Network (HPLMN) sends list of the PLMN, EPS PLMN list, where the UE can register to the EPS when the UE determines that 5GS of the currently registered PLMN is down in an existing NAS message or a new NAS message e.g. registration accept message, UE configuration update message. When the UE stores the EPS PLMN list when received in the NAS message. When the UE determines that it can't register to the 5GS of any available PLMN e.g. the 5GS of the currently registered PLMN is down and there is no other PLMN available to provide the 5G services, then the UE select a PLMN from the list of EPS PLMN list and attempt to attach to the PLMN for an EPS service.

### (Second Example of the Second Aspect)

In order to make the Disaster Roaming to EPS possible for 5G only UEs, it is beneficial if the 5G only UE knows in advance whether an EPS supports the Disaster Roaming to EPS for 5G only UEs or not before the 5G only UE initiates the Disaster Roaming service with the EPS. This example discloses the mechanism that eNodeB indicates to the 5G only UEs whether the Disaster Roaming to EPS for 5G only UEs supported by the EPC or not using SIB.

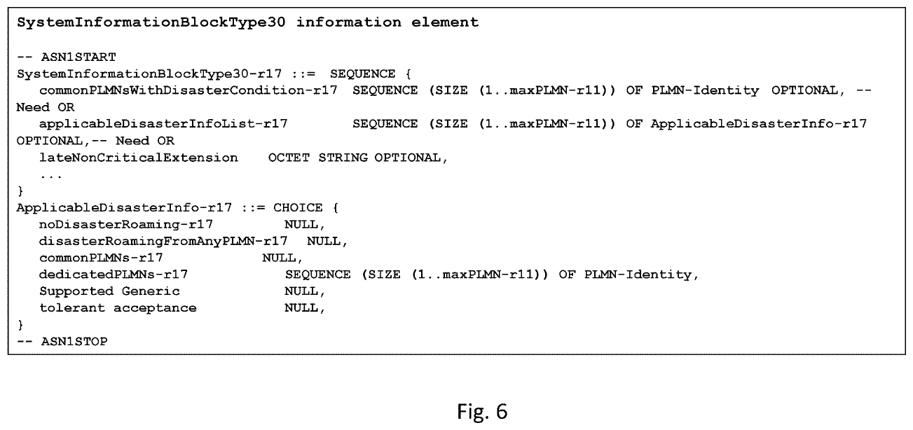

FIG. 6 indicates an example of Abstract Syntax Notation 1 (ASN.1) enhancement on the SIB for the Disaster Roaming service. FIG. 6 shows the System Information Block for disaster roaming service to EPS for 5G only UE.

The eNodeB of the PLMN that supports the Disaster Roaming to EPS for 5G only UEs broadcasts the following additional information parameters over the Broadcast Control Channel (BCCH).
Supported Generic or any other notation for a parameter broadcast by the eNoteB in one of SIB messages to indicate that roaming in disaster services are supported in EPS. There may be variation in the roaming in disaster services support in EPS, like: the eNodeB supports either 1) Disaster Roaming coming from both EPS and 5GS is allowed, 2) Disaster Roaming coming from EPS is only allowed or 3) Disaster Roaming coming from 5GS is only allowed.

For example, 1) and 2) are used in a situation where the EPS roaming service is normally prohibited but it is exceptionally allowed in case of the disaster situation. This may be used in a network where a national roaming in EPS is prohibited.
Tolerant acceptance or any other notation for a parameter broadcast by the eNodeB in one of SIB messages to indicate that roaming in disaster services may be provided by the EPS to those of UEs which don't have complete access right to the EPS.

For example, the UEs who have the Access Restriction Data set as “E-UTRAN not allowed” in their subscriber data, they may be accepted by the EPS if the Tolerant acceptance is indicated over the SIB.
Supports either 1) Disaster Roaming coming from both EPS and 5GS is allowed, 2) Disaster Roaming coming from EPS is only allowed or 3) Disaster Roaming coming from 5GS is only allowed. For example, 1) and 2) are used in a situation where the EPS roaming service is normally prohibited but it is exceptionally allowed in case of the disaster situation. This may be used in a network where a national roaming in EPS is prohibited.

In one example, a radio terminal corresponds to UE receives, from a radio station, information related to System Information Block (SIB) includes at least one of information indicating disaster roaming can be used, information indicating both disaster roaming using 4G service and 5G service can be used and information indicating the disaster roaming can be accepted without subscriber data.

### (Variant 1 of Second Example of the Second Aspect)

The NG-RAN may also broadcast new additional information over the BCCH. For example, SIB 15 may broadcast Supported Generic and Tolerant acceptance over the BCCH.

### (Third Example of the Second Aspect)

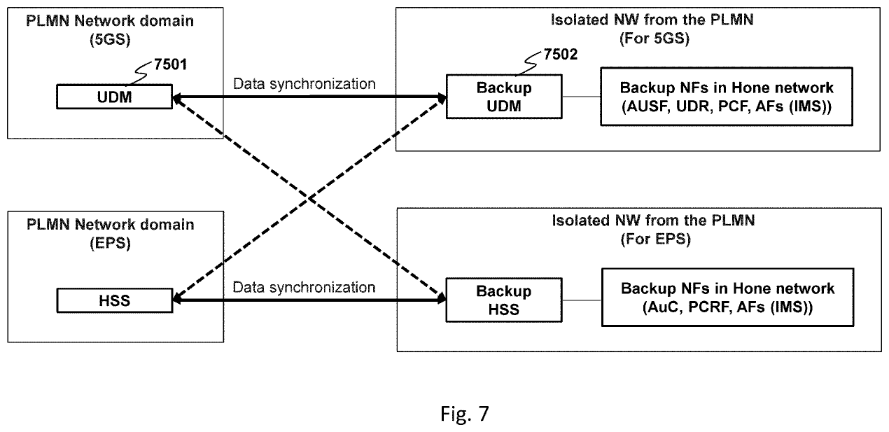

This example discloses the mechanism that the Disaster Roaming service is provided in a situation where the UDM and/or the HSS are not reachable due to disaster situation. FIG. 7 shows the scheme of the Subscriber data backup configuration.

The following enhancements to the 5GS and EPS are disclosed in this example:

### (Subscriber Data Backup)

New Data storages, Backup UDM 7502 and Backup HSS are newly created for Subscriber data backup to support the Disaster Roaming services for both 5GS and EPS respectively.
The Backup UDM 7502 and Backup HSS are located outside of the PLMN and isolated from the PLMN so that any network failure in the PLMN that leads the Disaster condition will not affect the availability of the Backup UDM and Backup HSS.
Subscriber data in the UDM 7501 is synchronized with the Backup UDM 7502. The Backup UDM 7502 may behave as the Unified Data Repository (UDR) as Unstructured data storage as defined section 4.2.5 in 3GPP TS 23.501 (PTL 3). In this case, data synchronization can be done based on the Nudsf service as defined in 3GPP TS 23.502 (PTL 4).
Subscriber data in the HSS is synchronized with the Backup HSS.
Together with the Backup UDM 7502, the Isolated NW from the PLMN (For 5GS) may have Authentication Server Function (AUSF), UDR, Policy Control Function (PCF) Application Function (AF)s in order to provide the connectivity service in case of disaster in 5GS.
Together with the Backup HSS, the Isolated NW from the PLMN (For EPS) may have Authentication Centre (AuC), Policy and Charging Rule Function (PCRF) and AFs in order to provide the connectivity service in case of disaster.
The UDM 7501 may synchronize with the Backup HSS in order to support the Disaster Roaming service in the EPS for 5GS subscribers.
The HSS may synchronize with the Backup UDM 7502 in order to support the Disaster Roaming service in the 5GS for EPS subscribers.
IPsec as described in 3GPP TS 33.210 (PTL 12) can be used for securely synchronizing UEs subscription data from UDM 7501 to Backup UDM 7502 and to Backup HSS, and similarly from HSS to Backup HSS and to Backup UDM 7502.

In one example, a Unified Data Management (UDM) in a 5G System (5GS) synchronizes data with a backup UDM for the 5GS. The UDM communicates with a backup Home Subscriber Server (HSS) for an Evolved Packet System (EPS).

In one example, a Home Subscriber Server (HSS) in an Evolved Packet System (EPS) synchronizes data with a backup HSS for the EPS. The HSS communicates with a backup Unified Data Management (UDM) for a 5G System (5GS).

### (Backup User Identity)

New user identities, Backup IMSI, Backup Subscription Permanent Identifier (SUPI) and Backup Subscription Concealed Identifier (SUCI) are newly introduced to support the Disaster Roaming services in case that the UDM and HSS are involved in the disaster in the PLMN.
The Backup SUPI, the Backup SUCI and Backup IMSI, are backed up user identities for SUPI, SUCI and IMSI respectively.
The Backup SUPI and Backup IMSI are stored in both the UE 3 and UDM 7501. The UE 3 obtains the Backup SUPI and Backup IMSI during the Registration procedure. The Backup IMSI may be used when the UE 3 have a Disaster Roaming service over the EPS.
The Backup IMSI and optionally Backup SUPI are stored in both the UE 3 and HSS. The UE 3 obtains the Backup IMSI and the Backup SUPI during the Attach procedure or Tracking Update procedure. The Backup SUPI may be used when the UE 3 have a Disaster Roaming service over the 5GS.
Any 3GPP nodes in the 5GS can route to the Backup UDM with the Backup SUPI or Backup SUCI without traversing the (failed) PLMN. One example, Backup SUPI has an mcc value and an mnc value other than the mcc and mnc for the HPLMN of the UE 3.
Any 3GPP nodes in the EPS can route to the Backup HSS with the Backup SUPI or Backup SUCI without traversing the (failed) PLMN. One example, Backup IMSI has an mcc value and mnc value other than the mcc and mnc for the HPLMN of the UE 3.

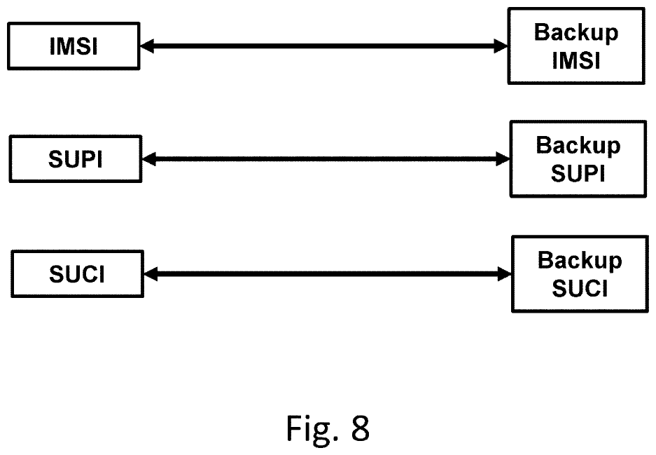

FIG. 8 shows the scheme of the Backup user identities.

In one example, a user equipment corresponds to UE stores at least one of backup Subscription Permanent Identifier (SUPI) and a backup International Mobile Subscriber Identity (IMS) for a disaster roaming service over an Evolved Packet System (EPS).

In one example, a Unified Data Management (UDM) stores at least one of backup a backup Subscription Permanent Identifier (SUPI) and a backup International Mobile Subscriber Identity (IMS) for a disaster roaming service over an Evolved Packet System (EPS).

In one example, a user equipment (UE) stores at least one of backup a backup Subscription Permanent Identifier (SUPI) and a backup International Mobile Subscriber Identity (IMS) for a disaster roaming service over a 5G System (5GS).

In one example, a Home Subscriber Server (HSS) stores at least one of backup a backup Subscription Permanent Identifier (SUPI) and a backup International Mobile Subscriber Identity (IMS) for a disaster roaming service over 5G system (5GS).

### (Registration Procedure in the 5GS (For Preparation of the Disaster Roaming Service))

This call flow in this example discloses the Registration procedure in the 5GS to send the Backup SUPI and the Backup IMSI to the UE 3. The Backup SUPI is used in case where the PLMN 1 encounters the disaster situation and the UDM 7501 cannot be reached from any 5GS nodes. The Backup IMSI is used in case where the PLMN 1 encounters the disaster situation and the HSS in the PLMN 1 cannot be reached from any EPS nodes.

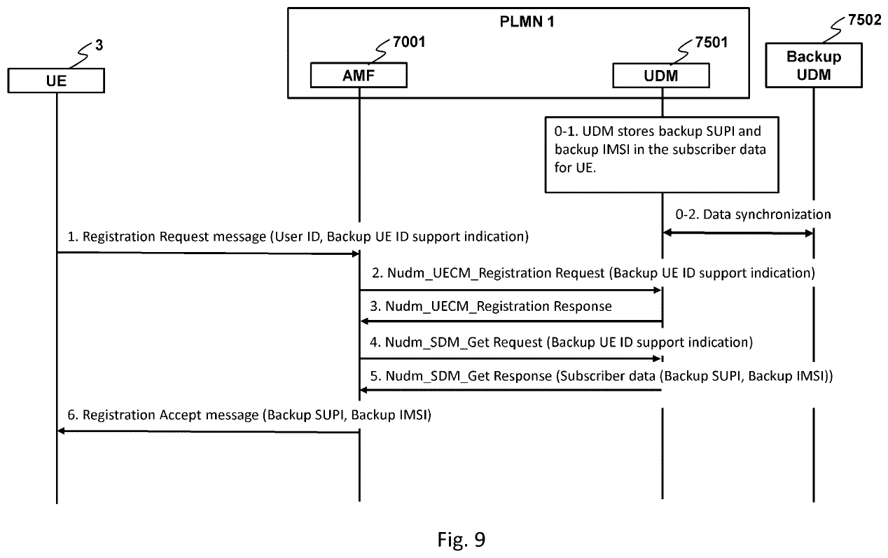

The detailed processes of the Third example of the Second Aspect are described below, with reference to FIG. 9. FIG. 9 shows the scheme of the Registration procedure for setting the Backup User identities in UE.

Step 0-1. The UDM 7501 stores the Backup SUPI and Backup IMSI in the subscriber data for UE 3.

Step 0-2. Subscriber data in the UDM 7501 is synchronized with the subscriber data in the Backup UDM 7502. This can be done securely using IPsec as described in 3GPP TS 33.210 (PTL 12).

Step 1. The UE 3 sends the Registration Request message to the AMF 7001 including Backup UE ID support indication. The Backup UE ID support indication indicates that the UE 3 supports to store the Backup SUPI and Backup IMSI that may be used in the Disaster Roaming Service.

Step 2. Upon reception of the Registration Request message from the UE 3, the AMF 7001 sends the Nudm_UECM_Registration Request message to the UDM 7501 including Backup UE ID support indication if the AMF 7001 receives the Backup UE ID support indication from the UE 3 in the Registration Request message in step 1.

Step 3. The UDM 7501 sends the Nudm_UECM_Registration Response message to the AMF 7001.

Step 4. The AMF 7001 sends the Nudm_SDM_Get Request message to the UDM 7501 including Backup UE ID support indication if the AMF 7001 receives the Backup UE ID support indication from the UE 3 in the Registration Request message in step 1. The AMF 7001 may not include the Backup UE ID support indication again if the Backup UE ID support indication is already sent to the UDM 7501 in the Nudm_UECM_Registration Request message in step 2.

Step 5. Upon reception of the Nudm_SDM_Get Request message from the AMF 7001, the UDM 7501 sends the Nudm_UECM_Response message to the AMF 7001 including the Backup SUPI and Backup IMSI only if the UDM 7501 has received the Backup UE ID support indication from the AMF 7001 in either Nudm_UECM_Registration Request message in step 2 or Nudm_SDM_Get Request message in step 4.

The Backup SUPI and Backup IMSI are set in the SoR container and sent to the AMF 7001 if the integrity protection or/and confidentiality protection are required.

Step 6. Upon reception of the Nudm_SDM_Get Response message from the UDM 7501, AMF 7001 sends the Registration Accept message to the UE 3 including Backup SUPI and Backup IMSI. The Backup SUPI and backup IMSI are sent from the UDM 7501 in the Steering of Roaming (SoR) container, then the AMF 7001 sends the SoR container to the UE 3 transparently by setting the SoR container to the Registration Accept message.

When the UE 3 receives the Registration Accept message including the Backup SUPI and Backup IMSI, the UE 3 stores Backup SUPI and Backup IMSI in a User Services Identity Module (USIM) or non-volatile memory in the UE 3. If the SoR container is received from the AMF 7001, the UE 3 decrypts the SoR container and obtains the Backup SUPI and Backup IMSI. Then, the UE 3 stores Backup SUPI and Backup IMSI in the USIM or non-volatile memory in the UE 3.

The Backup SUPI may be used as a replacement of the SUPI by the UE 3 later in the Registration procedure if the PLMN1 encounters the disaster situation and the UE 3 initiates the Disaster roaming service with 5GS in another VPLMN. The Backup IMSI may be used as a replacement of the IMSI in the UE 3 later in the Attach procedure if the PLMN1 encounters the disaster situation and the UE 3 initiates the Disaster roaming service with EPS in another VPLMN.

In one example, a core network node corresponds to AMF 7001 in 5G system (5GS) receives from a ratio terminal corresponds to UE, a backup radio terminal ID support indication. The core network node sends, to a Unified Data Management (UDM) in the 5GS, the backup radio terminal ID support indication. The core network node sends, to the UDM, the backup radio terminal ID support indication. The core network node receives, from the UDM, at least one of a Backup Subscription Permanent Identifier (SUPI) and a backup International Mobile Subscriber Identity (IMSI). The core network node sends, to the radio terminal, at least one of the Backup SUPI and the Backup IMSI.

### (Registration Procedure in the EPS (For Preparation of the Disaster Roaming Service))

This call flow in this example discloses the Attach procedure in the EPS to send the Backup IMSI and optionally Backup SUPI to the UE 3. The Backup IMSI is used in case where the PLMN 1 encounters the disaster situation and the HSS in the PLMN 1 cannot be reached from any EPS nodes. The Backup SUPI is used in case where the PLMN 1 encounters the disaster situation and the UDM 7501 cannot be reached from any 5GS nodes.

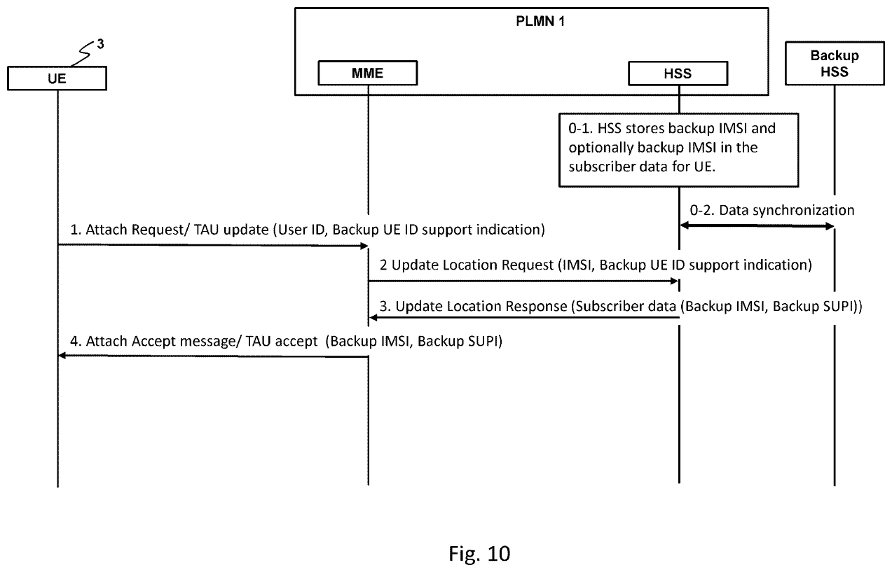

The detailed processes of the Third example of the Second Aspect are described below, with reference to FIG. 10. FIG. 10 shows the scheme of the Attach procedure for setting the Backup User identities in UE.

Step 0-1. The HSS stores the Backup IMSI and optionally Backup SUPI in the subscriber data for UE 3.

Step 0-2. Subscriber data in the HSS is synchronized with the subscriber data in the Backup HSS. This can be done securely using IPsec as described in 3GPP TS 33.210 (PTL 12).

Step 1. The UE 3 sends the Attach Request message or the TAU request message to the MME including Backup UE ID support indication. The Backup UE ID support indication indicates that the UE 3 supports to store the Backup IMSI and Backup SUPI that may be used in the Disaster Roaming Service.

Step 2. Upon reception of the Attach Request message or TAU request message from the UE 3, the AMF 7001 sends the Update Location Request message to the HSS including IMSI and Backup UE ID support indication if the MME receives the Backup UE ID support indication from the UE 3 in the Registration Request message or TAU request message in step 1.

Step 3. Upon reception of the Update Location Request message from the MME, the HSS sends the Update Location Response message to the MME including the Backup IMSI and optionally Backup SUPI only if the HSS has received the Backup UE ID support indication from the MME in the Update Location Request message from the MME in step 2.

Step 6. Upon reception of the Update Location Response message from the HSS, MME sends the Attach Accept message or the TAU accept message to the UE 3 including Backup IMSI and optionally Backup SUPI.

When the UE 3 receives the Attach Accept message or the TAU accept message including the Backup IMSI and optionally Backup SUPI, the UE 3 stores Backup IMSI and optionally Backup SUPI in the USIM or non-volatile memory in the UE 3.

The Backup IMSI may be used as a replacement of the IMSI in the UE 3 later in the Attach procedure if the PLMN1 encounters the disaster situation and the UE 3 initiates the Disaster roaming service with EPS in another VPLMN. The Backup SUPI may be used as a replacement of the SUPI by the UE 3 later in the Registration procedure if the PLMN1 encounters the disaster situation and the UE 3 initiates the Disaster roaming service with 5GS in another VPLMN.

In one example, a core network node corresponds to MME in Evolved Packet System (EPS) receives from a ratio terminal corresponds to UE), a backup radio terminal ID support indication. The core network node sends, to a Home Subscriber Server (HSS) in the EPS, the backup radio terminal ID support indication. The core network node receives, from the HSS, at least one of a backup Subscription Permanent Identifier (SUPI) and a International Mobile Subscriber Identity (IMSI). The core network node sends, to the radio terminal, at least one of the Backup SUPI and the backup IMSI.

(Registration Procedure for Disaster Roaming Service with Backup SUPI in the 5GS)

This call flow in this example discloses the Registration procedure in the 5GS with backup SUPI in case the PLMN 1 encounters the disaster situation and the UDM 7501 cannot be reached from any 5GS nodes. The Backup SUPI is used to have the Disaster Roaming service with the 5GS in another PLMN (PLMN 2) using the Backup SUPI.

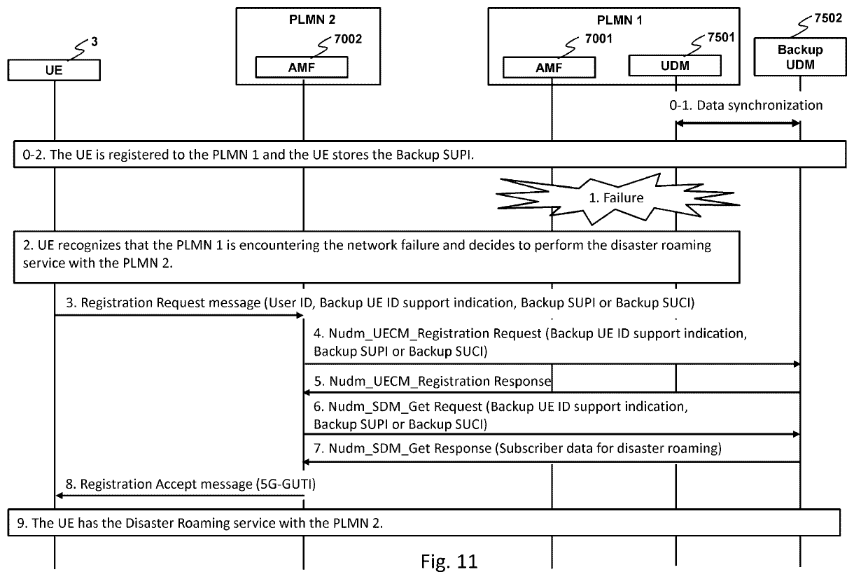

The detailed processes of the Third example of the Second Aspect are described below, with reference to FIG. 11. FIG. 11 shows the scheme of the Registration procedure for disaster Roaming service with Backup SUPI.

Step 0-1. Subscriber data in the UDM 7501 is synchronized with the subscriber data in the Backup UDM 7502. This can be done securely using IPsec as described in 3GPP TS 33.210 (PTL 12).

Step 0-2. The UE 3 stores the Backup SUPI based on the call flow in FIG. 9 or FIG. 10 of the Third example of the Second Aspect.

Step 1. The PLMN 1 encounters the Disaster situation. The UDM 7501 may not be reachable from any 5GC nodes due to the Disaster.

Step 2. The UE 3 recognizes that the PLMN 1 is encountering the network failure and decides to perform the disaster roaming service with the 5GS in PLMN 2. The First example of the First Aspect or the Second example of the First Aspect may be used for detection of network failure in PLMN 1.

Step 3. The UE 3 sends the Registration Request message to the AMF 7002 including User ID, Backup UE ID support indication and Backup SUPI or Backup SUCI. The Backup UE ID support indication indicates that the UE 3 supports to store the Backup SUPI and Backup IMSI that may be used in the Disaster Roaming Service. In addition to the User ID (It may be 5G-GUTI, SUCI or SUPI), Backup SUPI or Backup SUCI is included as an alternative User ID to fetch subscriber data. The Backup SUCI is calculated by the UE 3 based on the Backup SUPI.

Step 4. Upon reception of the Registration Request message from the UE 3, the AMF 7001 sends the Nudm_UECM_Registration Request message to the Backup UDM 7502 including Backup UE ID support indication and Backup SUPI or Backup SUCI if the AMF 7001 receives the Backup UE ID support indication and Backup SUPI or Backup SUCI from the UE 3 in the Registration Request message in step 3.

Step 5. The Backup UDM 7502 sends the Nudm_UECM_Registration Response message to the AMF 7002.

Step 6. The AMF 7002 sends the Nudm_SDM_Get Request message to the Backup UDM 7502 including Backup UE ID support indication and Backup SUPI or Backup SUCI if the AMF 7001 receives the Backup UE ID support indication and Backup SUPI or Backup SUCI from the UE 3 in the Registration Request message in step 3. The AMF 7002 may not include the Backup UE ID support indication and Backup SUPI or Backup SUCI again if the Backup UE ID support indication and Backup SUPI or Backup SUCI are already sent to the Backup UDM 7502 in the Nudm_UECM_Registration Request message in step 4.

Step 7. Upon reception of the Nudm_SDM_Get Request message from the AMF 7002, the Backup UDM 7502 sends the Nudm_UECM_Response message to the AMF 7002 including a Subscriber Data for Disaster.

Step 8. The AMF 7002 sends Registration Accept message to the UE 3 including the 5G-GUTI as the User ID. The UE 3 has successfully registered to the PLMN 2 for the Disaster Roaming service.

Step 9. Upon completion of the Registration procedure to the PLMN 2 for the Disaster Roaming service, The UE have a connectivity service over the 5GS in PLMN 2.

In one example, a core network node corresponds to AMF 7002 in a roaming network receives, from a radio terminal corresponds to UE, at least one of a backup radio terminal ID support indication, a backup Subscription Permanent Identifier (SUPI) and a backup Subscription Concealed Identifier (SUCI). The core network node sends, to a backup Unified Data Management (UDM), at least one of the Backup radio terminal ID support indication, the Backup SUPI and the Backup SUCI. The core network node sends, to the backup UDM, at least one of the Backup radio terminal ID support indication, Backup SUPI and Backup SUCI. The core network node receive, from the backup UDM, subscriber data for a disaster roaming.

### (Variant 11-1 of Third Example of the Second Aspect)

In step 4 in the FIG. 11, the AMF 7001 sends the Nudm_UECM_Registration Request message to the Backup UDM 7502 only if the AMF 7001 fails to send the Nudm_UECM_Registration Request message to the UDM 7501 using the User ID (It may be SUCI or SUPI) that is received in the Registration Request message from the UE 3 in step 3.

### (Variant 11-2 of Third Example of the Second Aspect)

The UE 3 may perform the Registration procedure after the UE 3 detects the network Failure in EPS in PLMN 1 while the UE 3 has attached to the EPS in PLMN 1. In this case, Data synchronization in step 0-1 is performed between HSS in the PLMN 1 and Backup UDM 7502 with subscriber data conversion from the EPS subscription to 5GS subscription and the Failure in step 1 occurs at the EPS in PLMN 1.

Registration Procedure for Disaster Roaming Service with Backup IMSI in the EPS

This call flow in this example discloses the Attach procedure or TAU procedure in the EPS with backup IMSI in case the PLMN 1 encounters the disaster situation and the HSS in the PLMN 1 cannot be reached from any EPS nodes. The Backup IMSI is used to have the Disaster Roaming service with the EPS in another PLMN (PLMN 2) using the Backup IMSI.

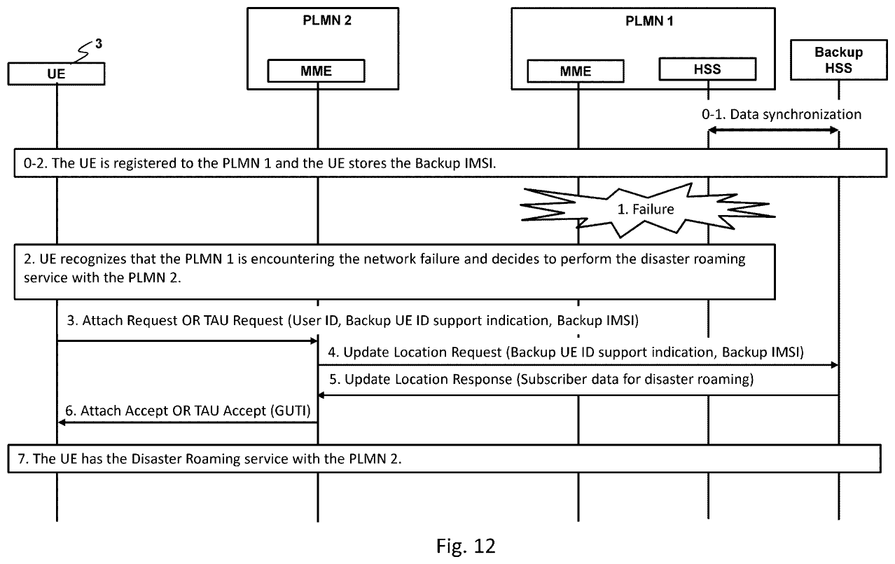

The detailed processes of the Third example of the Second Aspect are described below, with reference to FIG. 12. FIG. 12 show the scheme of the Attach procedure or TAU procedure for disaster Roaming service with Backup IMSI.

Step 0-1. Subscriber data in the HSS in PLMN 1 is synchronized with the subscriber data in the Backup HSS. This can be done securely using IPsec as described in 3GPP TS 33.210 (PTL 12).

Step 0-2. The UE 3 stores the Backup IMSI based on the call flow in FIG. 9 or FIG. 10 of the Third example of the Second Aspect.

Step 1. The PLMN 1 encounters the Disaster situation. The HSS in the PLMN 1 may not be reachable from any EPC nodes due to the Disaster.

Step 2. The UE 3 recognizes that the PLMN 1 is encountering the network failure and decides to perform the disaster roaming service with the EPS in PLMN 2. The First example of the First Aspect or the Second example of the First Aspect may be used for detection of network failure in PLMN 1.

Step 3. The UE 3 sends the Attach Request message or the TAU request message to the MME including User ID, Backup UE ID support indication and Backup IMSI. The Backup UE ID support indication indicates that the UE 3 supports to store the Backup IMSI that may be used in the Disaster Roaming Service. In addition to the User ID (It may be GUTI or IMSI), Backup IMSI is included as an alternative User ID to fetch subscriber data.

Step 4. Upon reception of the Attach Request message or the TAU request message from the UE 3, the MME in the PLMN 2 sends the Update Location Request message to the Backup HSS including Backup UE ID support indication and Backup IMSI if the AMF 7001 receives the Backup UE ID support indication and Backup IMSI from the UE 3 in the Attach Request message or the TAU request message in step 3.

Step 5. The Backup HSS sends the Update Location Response message to the MME in the PLMN 2 including a Subscriber Data for Disaster.

Step 6. The MME in the PLMN 2 sends Attach Accept message or the TAU Accept message to the UE 3 including the GUTI as the User ID. The UE 3 has successfully registered to the PLMN 2 for the Disaster Roaming service.

Step 7. Upon completion of the Registration procedure to the PLMN 2 for the Disaster Roaming service, The UE have a connectivity service over the EPS in PLMN 2.

In one example, a core network node corresponds to MME in a roaming network receives, from a terminal corresponds to UE, at least one of a backup radio terminal ID, a support indication and a backup International Mobile Subscriber Identity (IMSI). The core network node sends, to a backup Home Subscriber Server (HSS), a backup radio terminal ID support indication and the backup IMSI. The core network node receives from the backup HSS, a subscriber data for disaster roaming. The core network node sends, to the radio terminal (UE), a message.

### (Variant 12-1 of Third Example of the Second Aspect)

In step 4 in the FIG. 12, the MME in the PLMN 2 sends the Update Location Request message to the Backup HSS only if the MME in the PLMN 2 fails to send the Update Location Request message to the HSS in the PLMN 1 using the User ID (I.e., IMSI).

### (Variant 12-2 of Third Wxample of the Second Aspect)

The UE 3 may perform the Attach procedure or the Tracking Update procedure after the UE 3 detects the network Failure in 5GS in PLMN 1 while the UE 3 has registered to the 5GS in PLMN 1. In this case, Data synchronization in step 0-1 is performed between UDM 7501 in the PLMN 1 and Backup HSS with subscriber data conversion from the 5GS subscription to EPS subscription and the Failure in step 1 occurs at the 5GS in PLMN 1.

### (System Overview)

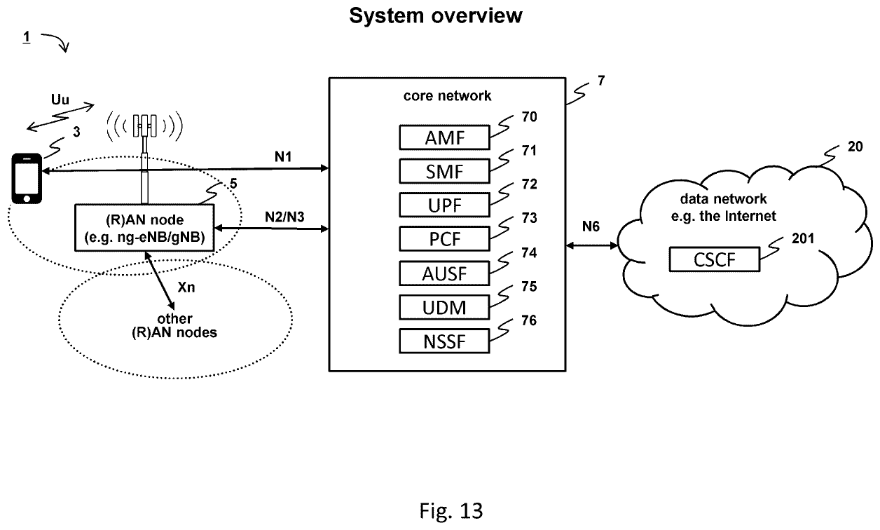

FIG. 13 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice Selection Function (NSSF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type. The data network may include an AAA 201.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
#establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
#masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
#guami-Type, iab-NodeIndication, idle Meas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
#5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
#5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-NI mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
#SOR transparent container.
Authentication Request message: This message is sent from the AMF 70 to the UE 3. In addition to the parameters that are disclosed by Aspects in this disclosure, following parameters may be included together in the Authentication Request message.
#ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
#Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
#ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
#Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
#EAP message.
Service Request message: This message is sent from the UE 3 to the AMF 70. In addition to the parameters that are disclosed by Aspects in this disclosure, following parameters may be populated together in the Service Request message.
#ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
#PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
#5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
#Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
-Configuration Update Complete message: This message is sent from the UE 3 to the AMF 70. In addition to the parameters that are disclosed by Aspects in this disclosure, following parameters may be populated together in the Configuration Update Complete message.
#Configuration update complete message identity.

### (User Equipment (UE))

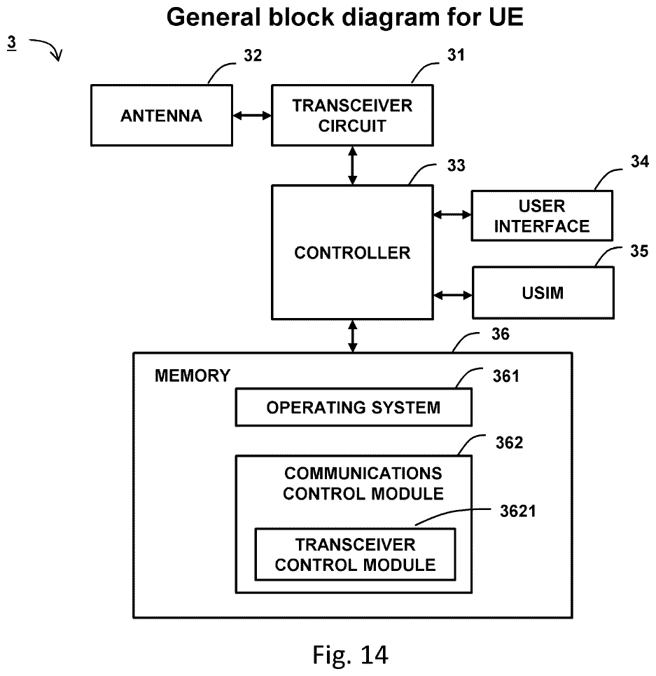

FIG. 14 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery;

manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc. ).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### ((R)AN Node)

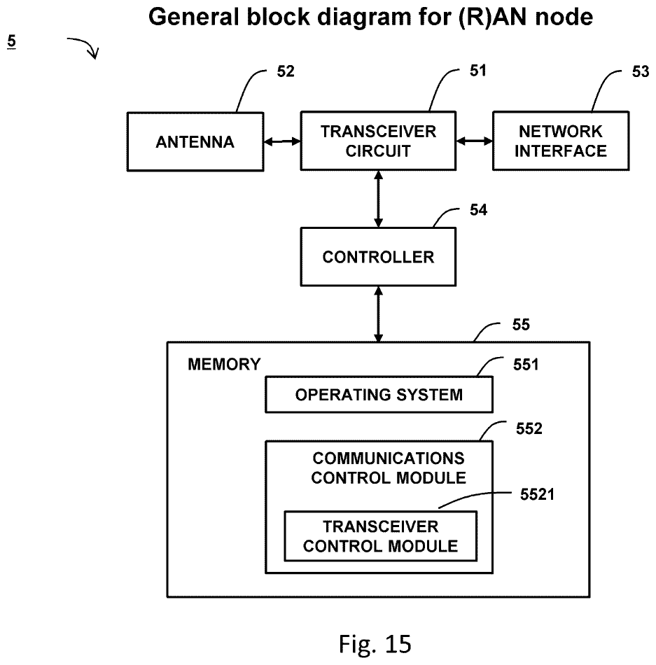

FIG. 15 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g.

RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

The Current RAN 501 and the Candidate RAN 502 may have same components to the (R)AN node 5. The (R)AN node 5 may be expressed as a RAN node, RAN, (R)AN etc.

### (System Overview of (R)AN Node 5 Based on O-RAN Architecture)

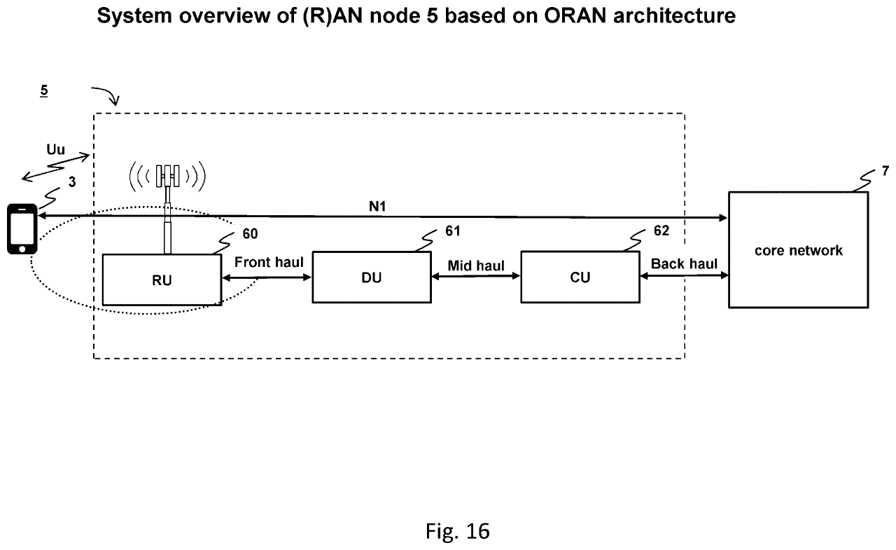

FIG. 16 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### (Radio Unit (RU))

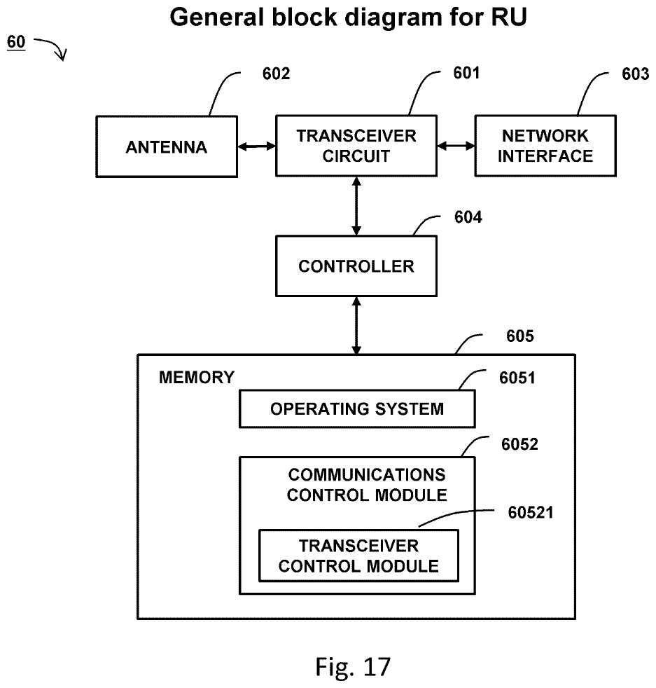

FIG. 17 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly) . The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimation and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### (Distributed Unit (DU))

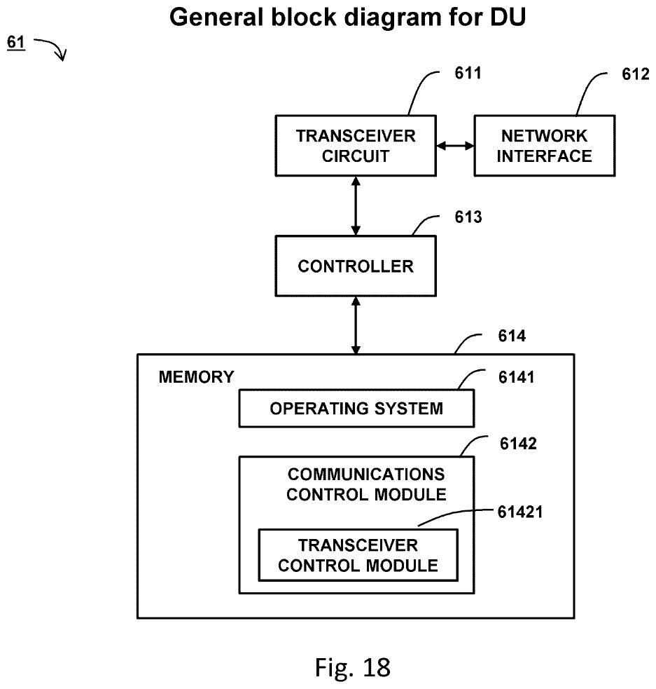

FIG. 18 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### (Centralized Unit (CU))

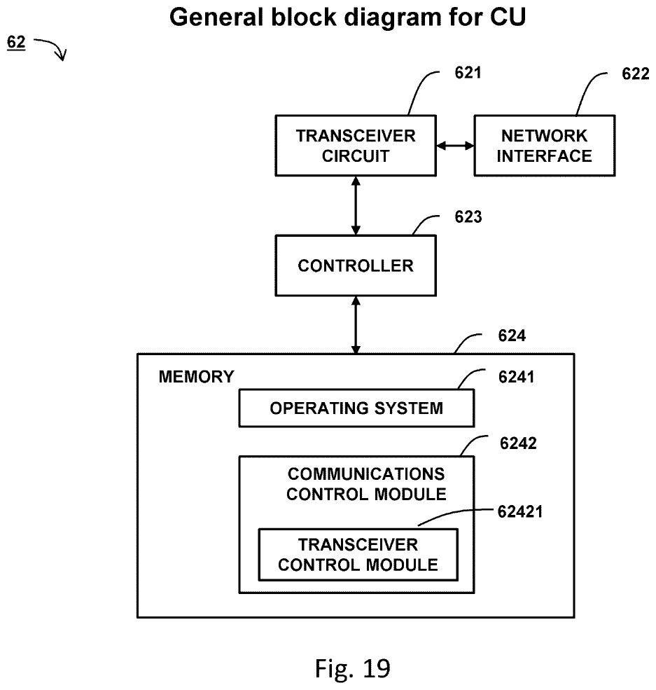

FIG. 19 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### (AMF)

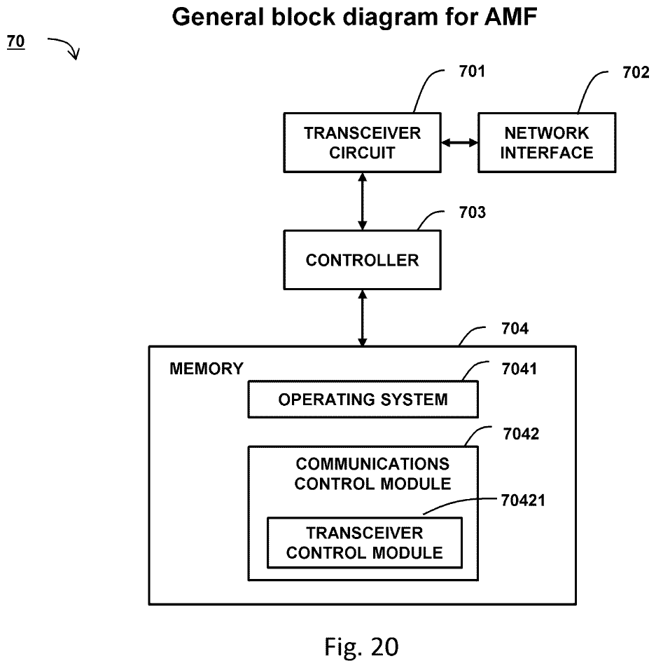

FIG. 20 is a block diagram illustrating the main components of the AMF 70. As shown, the apparatus includes a transceiver circuit 701 which is operable to transmit signals to and to receive signals from other nodes (including the UE 3, the NSSF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e. g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### (PCF)

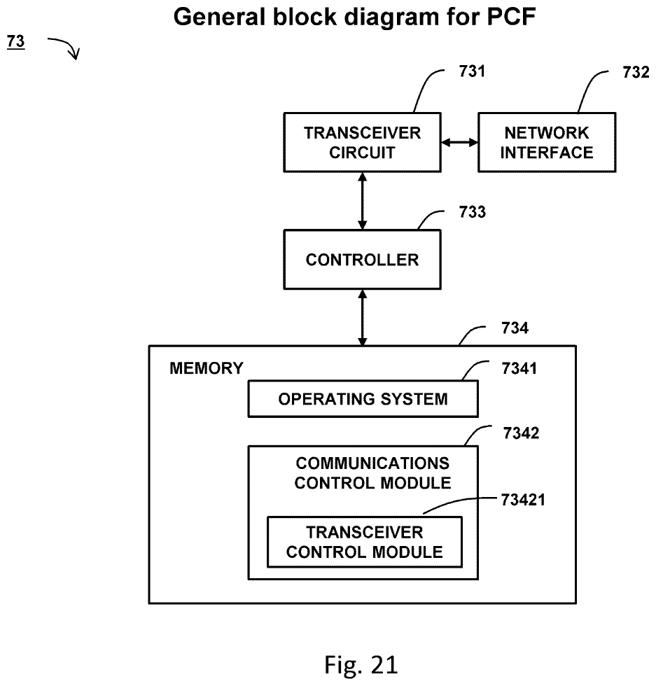

FIG. 21 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful method based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### (AUSF)

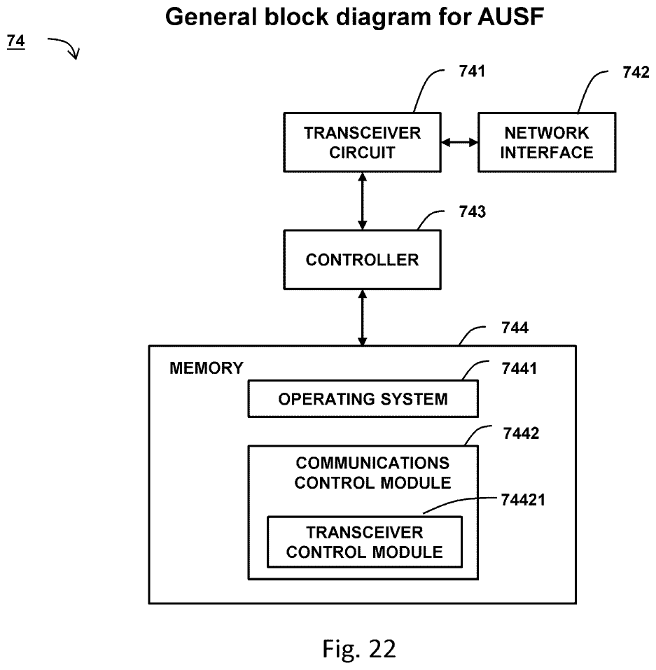

FIG. 22 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful method based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### (UDM)

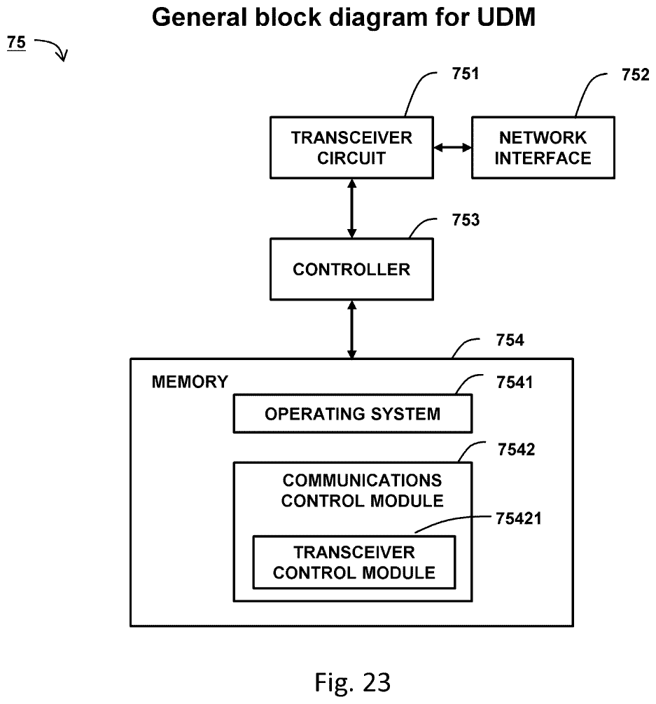

FIG. 23 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful method based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### (NSSF)

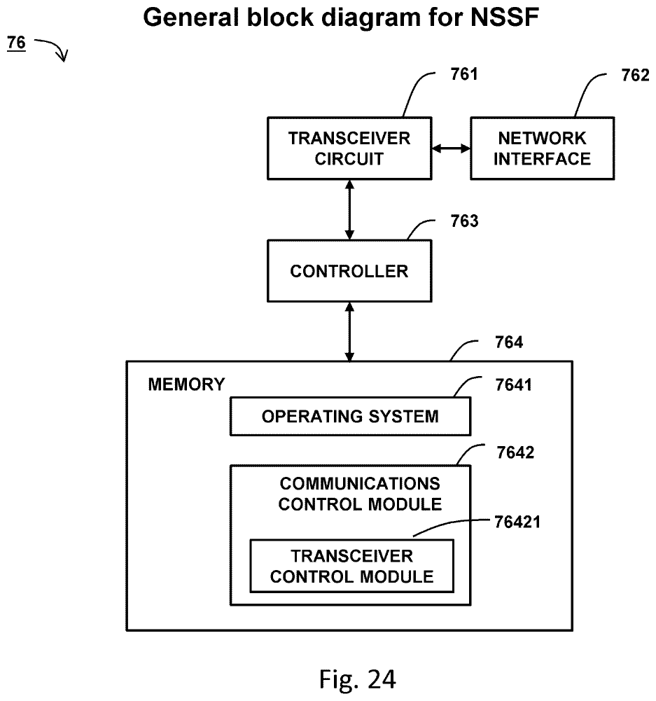

FIG. 24 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful method based on the service based interfaces) relating to mobility management procedures (for the UE 3).

The NSSF 76 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### (Modifications and Alternatives)

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

### (Supplementary Note 1)

A radio station comprising:
a memory; and
at least one processor configured to access the memory and configured to:
send, to a first core network node in a first network, a set up request message including information for a list of connected network,
receive, from the first core network node, a set up response message including at least one of information for a list of roaming networks and information for priority order for the roaming networks,
detect a failure of connection between the first core network node or another core network node in the first network; and
send, to a radio terminal, at least one of information related to disaster condition for the first network, information for the first network,
information for the list of roaming networks and the information for priority order for the roaming networks.

### (Supplementary Note 2)

The radio station according to Supplementary note 1, wherein the at least one of the information related to disaster condition for the first network, information for the first network, list of roaming networks and information for priority order for the roaming networks is included in a System Information Block (SIB) message or a Radio Resource Control Release message.

### (Supplementary Note 3)

A first core network node in a first network comprising:
a memory; and
at least one processor configured to access the memory and configured to:
receive, from a radio station a set up request message including information for a list of connected network; and
send, to the radio station, a set up response message including at least one of information for a list of disaster roaming networks and information for priority order for the disaster roaming networks.

### (Supplementary Note 4)

A radio terminal comprising:
a memory; and
at least one processor configured to access the memory and configured to:
receive, from a radio station at least one of information related to disaster condition for the first network, information for a first network, information for a list of roaming networks and the information for priority order for the roaming networks; and
send, to a second core network node in the roaming network, a registration request message with a parameter used to initiate a disaster roaming service.

### (Supplementary Note 5)

A method for a radio station comprising:
means for sending, to a first core network node in a first network, a set up request message including information for a list of connected network,
means for receiving, from the first core network node, a set up response message including at least one of information for a list of roaming networks and information for priority order for the roaming networks, means for detecting a failure of connection between the first core network node or another core network node in the first network; and
means for send, to a radio terminal, at least one of information related to disaster condition for the first network, information for the first network, information for the list of roaming networks and the information for priority order for the roaming networks.

### (Supplementary Note 6)

The method according to Supplementary note 5, wherein the at least one of the information related to disaster condition for the first network, information for the first network, list of roaming networks and information for priority order for the roaming PLMNs is included in a System Information Block (SIB) message or a Radio Resource Control Release message.

### (Supplementary Note 7)

A method for a first core network node in a first network comprising:
means for receiving, from a radio station a set up request message including information for a list of connected network; and
means for sending, to the radio station, a set up response message including at least one of information for a list of disaster roaming networks and information for priority order for the disaster roaming networks.

### (Supplementary Note 8)

A method for a radio terminal comprising:
means for receiving, from a radio station at least one of information related to disaster condition for the first network, information for a first network, information for a list of roaming networks and the information for priority order for the roaming networks; and
means for sending, to a second core network node in the roaming network, a registration request message with a parameter used to initiate a disaster roaming service.

### (Supplementary Note 9)

A first core network node in a first network comprising:
a memory; and
at least one processor configured to access the memory and configured to:
receive, from a radio station a set up request message including information for a list of connected network; and
send, to the radio station a set up response message including at least one of information for a list of disaster roaming networks and information for priority order for the disaster roaming networks,
receive, from second core network node in the first network, information indicates minimization of service interruption is required,
send, to the radio station, information including at least one of new cause parameter, disaster condition indication parameter and available services parameter.

### (Supplementary Note 10)

A method for a first core network node in a first network comprising:
means for receiving, from a radio station a set up request message including information for a list of connected network; and
means for sending, to the radio station, a set up response message including at least one of information for a list of disaster roaming networks and information for priority order for the disaster roaming networks,
means for receiving, from second core network node in the first network, information indicates minimization of service interruption is required,
means for sending, to the radio station, information including at least one of new cause parameter, disaster condition indication parameter and available services parameter.

### (Supplementary Note 11)

A radio terminal comprising:
a memory; and
at least one processor configured to access the memory and configured to:
decide to perform a roaming service related to a disaster,
send, to a radio station, Radio Resource Control (RRC) setup request message including information indicates that the radio terminal has ability to support the roaming service related to the disaster,
receive, from the radio station, at least one of information related to disaster condition for a first network, information for the first network related to the disaster, information for a list of roaming networks and information for priority order for the roaming networks,
send, to the radio station, RRC setup complete message including at least one of information for the first network, the information indicates that the radio terminal has ability to support the roaming service related to disaster and the information related to disaster condition for the first network,
send, to the radio station, information related to the roaming network,
send, to the radio station, a Non Access Stratum (NAS) container information including registration request information including at least one of the information indicates that the radio terminal has ability to support the roaming service related to disaster and the information related to disaster condition for the first network.

### (Supplementary Note 12)

A radio station comprising:
a memory; and
at least one processor configured to access the memory and configured to:
receive, from a radio terminal, Radio Resource Control (RRC) setup request message including information indicates that the radio terminal has ability to support a roaming service related to a disaster,
send, to the radio terminal, at least one of information related to disaster condition for a first network, information for the first network related to the disaster, information for a list of roaming networks and information for priority order for the roaming networks,
receive, from the radio terminal, RRC setup complete message including at least one of information for the first network, the information indicates that the radio terminal has ability to support the roaming service related to disaster and the information related to disaster condition for the first network,
receive, from the radio terminal, information related to the roaming network,
receive, from the radio terminal, a Non Access Stratum (NAS) container information including registration request information including at least one of the information indicates that the radio terminal has ability to support the roaming service related to the disaster and the information related to disaster condition for the first network; and
send, to a third core network node in the roaming network (PLMN2), a registration request message including at least one of the information indicates that the radio terminal has ability to support the roaming service related to the disaster and the information related to disaster condition for the first network.

### (Supplementary Note 13)

A fourth core network node in a first network (PLMN1) related to a disaster comprising:
a memory; and
at least one processor configured to access the memory and configured to:
receive, from a third core network node in a roaming network, a message including at least one of information indicates that a radio terminal has ability to support a roaming service related to the disaster and information related to disaster condition for the first network,
receive, from the third core network node, a message including at least one of the information indicates that the radio terminal has ability to support the roaming service related to the disaster and the information related to disaster condition for the first network; and
send, to the third core network node, a message including subscriber data.

### (Supplementary Note 14)

A third core network node in a second network comprising:
a memory; and
at least one processor configured to access the memory and configured to:
receive, from a radio station, a registration request message including at least one of information indicates that a radio terminal has ability to Support a roaming service related to a disaster and information related to disaster condition for a first network,
send, to a fourth core network node in a first network related to the disaster, a message including at least one of the information indicates that the radio terminal has ability to support the roaming service related to the disaster and the information related to disaster condition for the first network,
send, to the fourth core network node, a message including at least one of the information indicates that the radio terminal has ability to support the roaming service related to the disaster and the information related to disaster condition for the first network; and
receive, from the fourth core network node, a message including subscriber data.

### (Supplementary Note 15)

A method for a radio terminal comprising:
means for deciding to perform a roaming service related to a disaster,
means for sending, to a radio station, Radio Resource Control (RRC) setup request message including information indicates that the radio terminal has ability to support the roaming service related to the disaster,
means for receiving, from the radio station, at least one of information related to disaster condition for a first network, information for the first network related to the disaster, information for a list of roaming networks and information for priority order for the roaming networks,
means for sending, to the radio station, RRC setup complete message including at least one of information for the first network, the information indicates that the radio terminal has ability to support the roaming service related to disaster and the information related to disaster condition for the first network,
means for sending, to the radio station, information related to the roaming network,
means for sending, to the radio station, a Non Access Stratum (NAS) container information including registration request information including at least one of the information indicates that the radio terminal has ability to support the roaming service related to disaster and the information related to disaster condition for the first network.

### (Supplementary Note 16)

A method for a radio station comprising:
means for receiving, from a radio terminal, Radio Resource Control (RRC) setup request message including information indicates that the radio terminal has ability to support a roaming service related to a disaster
means for sending, to the radio terminal, at least one of information related to disaster condition for a first network, information for the first network related to the disaster, information for a list of roaming networks and information for priority order for the roaming networks,
means for receiving, from the radio terminal, RRC setup complete message including at least one of information for the first network, the information indicates that the radio terminal has ability to support the roaming service related to disaster and the information related to disaster condition for the first network,
means for receiving, from the radio terminal, information related to the roaming network,
means for receiving, from the radio terminal, a Non Access Stratum (NAS) container information including registration request information including at least one of the information indicates that the radio terminal has ability to support the roaming service related to the disaster and the information related to disaster condition for the first network; and
means for sending, to a third core network node in the roaming network, a registration request message including at least one of the information indicates that the radio terminal has ability to support the roaming service related to the disaster and the information related to disaster condition for the first network.

### (Supplementary Note 17)

A method for a fourth core network node in a first network related to a disaster comprising:
means for receiving, from a third core network node in a roaming network, a message including at least one of information indicates that a radio terminal has ability to support a roaming service related to the disaster and information related to disaster condition for the first network,
means for receiving, from the third core network node, a message including at least one of the information indicates that the radio terminal has ability to support the roaming service related to the disaster and the information related to disaster condition for the first network; and
means for sending, to the third core network node, a message including subscriber data.

### (Supplementary Note 18)

A method for a third core network node in a second network comprising:
means for receiving, from a radio station, a registration request message including at least one of information indicates that a radio terminal has ability to support a roaming service related to a disaster and information related to disaster condition for a first network,
means for sending, to a fourth core network node in a first network related to the disaster, a message including at least one of the information indicates that the radio terminal has ability to support the roaming service related to the disaster and the information related to disaster condition for the first network,
means for sending, to the fourth core network node, a message including at least one of the information indicates that the radio terminal has ability to support the roaming service related to the disaster and the information related to disaster condition for the first network; and
means for receiving, from the fourth core network node, a message including subscriber data.

### (Supplementary Note 19)

A radio terminal comprising:
a memory; and
at least one processor configured to access the memory and configured to:
decide to perform a roaming service related to a disaster,
send, to a radio station, Radio Resource Control (RRC) reestablishment request message including information indicates that the radio terminal has ability to support the roaming service related to the disaster,
receive, from the radio station, at least one of information related to disaster condition for a first network, information for the first network related to the disaster, information for a list of roaming networks and information for priority order for the roaming networks,
send, to the radio station, RRC setup complete message including at least one of information for the first network, the information indicates that the radio terminal has ability to support the roaming service related to disaster and the information related to disaster condition for the first network,
send, to the radio station, information related to the roaming network,
send, to the radio station, a Non Access Stratum (NAS) container information including registration request information including at least one of the information indicates that the radio terminal has ability to support the roaming service related to disaster and the information related to disaster condition for the first network.

### (Supplementary Note 20)

A radio station comprising:
a memory; and
at least one processor configured to access the memory and configured to:
receive, from a radio terminal, Radio Resource Control (RRC) reestablishment request message including information indicates that the radio terminal has ability to support a roaming service related to a disaster,
send, to the radio terminal, at least one of information related to disaster condition for a first network, information for the first network related to the disaster, information for a list of roaming networks and information for priority order for the roaming networks,
receive, from the radio terminal, RRC setup complete message including at least one of information for the first network, the information indicates that the radio terminal has ability to support the roaming service related to disaster and the information related to disaster condition for the first network,
receive, from the radio terminal, information related to the roaming network,
receive, from the radio terminal, a Non Access Stratum (NAS) container information including registration request information including at least one of the information indicates that the radio terminal has ability to support the roaming service related to the disaster and the information related to disaster condition for the first network; and
send, to a third core network node in the roaming network, a registration request message including at least one of the information indicates that the radio terminal has ability to support the roaming service related to the disaster and the information related to disaster condition for the first network.

### (Supplementary Note 21)

A method for a radio terminal comprising:
means for deciding to perform a roaming service related to a disaster,
means for sending, to a radio station, Radio Resource Control (RRC) reestablishment request message including information indicates that the radio terminal has ability to support the roaming service related to the disaster,
means for receiving, from the radio station, at least one of information related to disaster condition for a first network information for the first network related to the disaster, information for a list of roaming networks and information for priority order for the roaming networks,
means for sending, to the radio station, RRC setup complete message including at least one of information for the first network, the information indicates that the radio terminal has ability to support the roaming service related to disaster and the information related to disaster condition for the first network,
means for sending, to the radio station, information related to the roaming network,
means for sending, to the radio station, a Non Access Stratum (NAS) container information including registration request information including at least one of the information indicates that the radio terminal has ability to support the roaming service related to disaster and the information related to disaster condition for the first network.

### (Supplementary Note 22)

A method for a radio station comprising:
means for receiving, from a radio terminal, Radio Resource Control (RRC) reestablishment request message including information indicates that the radio terminal has ability to support a roaming service related to a disaster,
means for sending, to the radio terminal, at least one of information related to disaster condition for a first network, information for the first network related to the disaster, information for a list of roaming networks and information for priority order for the roaming networks,
means for receiving, from the radio terminal, RRC setup complete message including at least one of information for the first network, the information indicates that the radio terminal has ability to support the roaming service related to disaster and the information related to disaster condition for the first network,
means for receiving, from the radio terminal, information related to the roaming network,
means for receiving, from the radio terminal, a Non Access Stratum (NAS) container information including registration request information including at least one of the information indicates that the radio terminal has ability to support the roaming service related to the disaster and the information related to disaster condition for the first network; and
means for sending, to a third core network node in the roaming network (PLMN2), a registration request message including at least one of the information indicates that the radio terminal has ability to support the roaming service related to the disaster and the information related to disaster condition for the first network.

### (Supplementary Note 23)

A radio terminal in 5G network comprising:
a memory; and
at least one processor configured to access the memory and configured to:
decide to perform a roaming service related to a disaster,
send, to a fifth core network node in 4G network, information indicates that the radio terminal has ability to support the roaming service related to the disaster.

### (Supplementary Note 24)

A sixth core network node in 5G network comprising:
a memory; and
at least one processor configured to access the memory and configured to:
receive, from a fifth core network node in 4G network, information indicates that the radio terminal has ability to support the roaming service related to the disaster; and
send, to the fifth core network node subscriber data.

### (Supplementary Note 25)

A method for a radio terminal in 5G network comprising:
means for deciding to perform a roaming service related to a disaster,
means for sending, to a fifth core network node in 4G network, information indicates that the radio terminal has ability to support the roaming service related to the disaster.

### (Supplementary Note 26)

A method for a sixth core network node in 5G network comprising:
means for receiving, from a fifth core network node in 4G network, information indicates that the radio terminal has ability to support the roaming service related to the disaster; and
means for sending, to the fifth core network node subscriber data.

### (Supplementary Note 27)

A radio terminal comprising:
a memory; and
at least one processor configured to access the memory and configured to:
receive, from a radio station, information related to System Information Block (SIB) includes at least one of information indicating disaster roaming can be used, information indicating both disaster roaming using 4G service and 5G service can be used and information indicating the disaster roaming can be accepted without subscriber data.

### (Supplementary Note 28)

A method for a radio terminal comprising:
means for receiving, from a radio station, information related to System Information Block (SIB) includes at least one of information indicating disaster roaming can be used, information indicating both disaster roaming using 4G service and 5G service can be used and information indicating the disaster roaming can be accepted without subscriber data.

### (Supplementary Note 29)

A Unified Data Management (UDM) in a 5G System (5GS) comprising:
a memory; and
at least one processor configured to access the memory and configured to:
synchronize data with a backup UDM for the 5GS; or
communicate with a backup Home Subscriber Server (HSS) for an Evolved Packet System (EPS).

### (Supplementary Note 30)

A Home Subscriber Server (HSS) in an Evolved Packet System (EPS) comprising:
a memory; and
at least one processor configured to access the memory and configured to synchronize data with a backup HSS for the EPS; or
communicate with a backup Unified Data Management (UDM) for a 5G System (5GS).

### (Supplementary Note 31)

A method for a Unified Data Management (UDM) in a 5G System (5GS) comprising:
means for synchronizing data with a backup UDM for the 5GS; or
means for communicating with a backup Home Subscriber Server (HSS) for an Evolved Packet System (EPS).

### (Supplementary Note 32)

A method for a Home Subscriber Server (HSS) in an Evolved Packet System (EPS) comprising:
means for synchronizing data with a backup HSS for the EPS; or
means for communicating with a backup Unified Data Management (UDM) for a 5G System (5GS).

### (Supplementary Note 33)

A user equipment (UE) comprising:
a memory; and
at least one processor configured to access the memory and configured to:
store at least one of backup Subscription Permanent Identifier (SUPI) and a backup International Mobile Subscriber Identity (IMS) for a disaster roaming service over an Evolved Packet System (EPS).

### (Supplementary Note 34)

A Unified Data Management (UDM) comprising:
a memory; and
at least one processor configured to access the memory and configured to:
store at least one of backup a backup Subscription Permanent Identifier (SUPI) and a backup International Mobile Subscriber Identity (IMS) for a disaster roaming service over an Evolved Packet System (EPS).

### (Supplementary Note 35)

A user equipment (UE) comprising:
a memory; and
at least one processor configured to access the memory and configured to:
store at least one of backup a backup Subscription Permanent Identifier (SUPI) and a backup International Mobile Subscriber Identity (IMS) for a disaster roaming service over a 5G System (5GS).

### (Supplementary Note 36)

A Home Subscriber Server (HSS) comprising:
a memory; and
at least one processor configured to access the memory and configured to:
store at least one of backup a backup Subscription Permanent Identifier (SUPI) and a backup International Mobile Subscriber Identity (IMS) for a disaster roaming service over 5G system (5GS).

### (Supplementary Note 37)

A method for a user equipment (UE) comprising:
means for storing at least one of a backup Subscription Permanent Identifier (SUPI) and a backup International Mobile Subscriber Identity (IMS) for a disaster roaming service over Evolved Packet System (EPS).

### (Supplementary Note 38)

A method for a Unified Data Management (UDM) comprising:
means for storing at least one of backup a backup Subscription Permanent Identifier (SUPI) and a backup International Mobile Subscriber Identity (IMS) for a disaster roaming service over Evolved Packet System (EPS).

### (Supplementary Note 39)

A method for a user equipment (UE) comprising:
means for storing at least one of backup a backup Subscription Permanent Identifier (SUPI) and a backup International Mobile Subscriber Identity (IMS) for a disaster roaming service over 5GS.

### (Supplementary Note 40)

A method for a Home Subscriber Server (HSS) comprising:
means for storing at least one of a backup Subscription Permanent Identifier (SUPI) and a backup International Mobile Subscriber Identity (IMS) for a disaster roaming service over 5G system (5GS).

### (Supplementary Note 41)

A core network node in 5G system (5GS) comprising:
a memory; and
at least one processor configured to access the memory and configured to:
receive from a ratio terminal (UE), a backup radio terminal ID support indication,
send, to a Unified Data Management (UDM) in the 5GS, the backup radio terminal ID support indication,
send, to the UDM, the backup radio terminal ID support indication,
receive, from the UDM, at least one of a Backup Subscription Permanent Identifier (SUPI) and a backup International Mobile Subscriber Identity (IMSI) and
send, to the radio terminal, at least one of the Backup SUPI and the Backup IMSI.

### (Supplementary Note 42)

A method for a core network node in 5G system (5GS) comprising:
means for receiving, from a ratio terminal (UE), a Backup radio terminal ID support indication,
means for sending, to a Unified Data Management (UDM) in the 5GS, the Backup radio terminal ID support indication,
means for sending, to the UDM, the Backup radio terminal ID support indication,
means for receiving, from the UDM, at least one of a Backup Subscription Permanent Identifier (SUPI) and a Backup International Mobile Subscriber Identity (IMS) and
means for sending, to the radio terminal, at least one of the Backup SUPI and the Backup IMSI.

### (Supplementary Note 43)

A core network node in Evolved Packet System (EPS) comprising:
a memory; and
at least one processor configured to access the memory and configured to:
receive from a ratio terminal, a backup radio terminal ID support indication,
send, to a Home Subscriber Server (HSS) in the EPS, the backup radio terminal ID support indication,
receive, from the HSS, at least one of a backup Subscription Permanent Identifier (SUPI)and an International Mobile Subscriber Identity (IMSI); and
send, to the radio terminal, at least one of the Backup SUPI and the backup IMSI.

### (Supplementary Note 44)

A method for a core network node in Evolved Packet System (EPS) comprising:
means for receiving from a ratio terminal, a backup radio terminal ID support indication,
means for sending, to a Home Subscriber Server (HSS) in the EPS, the Backup radio terminal ID support indication,
means for receiving, from the HSS, at least one of a backup Subscription Permanent Identifier (SUPI)and an International Mobile Subscriber Identity (IMSI); and
means for send, to the radio terminal, at least one of the backup SUPI and the Backup IMSI.

### (Supplementary Note 45)

A core network node in a roaming network comprising:
a memory; and
at least one processor configured to access the memory and configured to:
receive, from a radio terminal, at least one of a backup radio terminal ID support indication, a backup Subscription Permanent Identifier (SUPI) and a backup Subscription Concealed Identifier (SUCI),
send, to a backup Unified Data Management (UDM), at least one of the Backup radio terminal ID support indication, the Backup SUPI and the Backup SUCI,
send, to the backup UDM, at least one of the Backup radio terminal ID support indication, Backup SUPI and Backup SUCI; and
receive, from the backup UDM, subscriber data for a disaster roaming.

### (Supplementary Note 46)

A method for a core network node in a roaming network comprising:
means for receiving, from a radio terminal, at least one of a backup radio terminal ID support indication, a backup Subscription Permanent Identifier (SUPI) and a backup Subscription Concealed Identifier (SUCI),
means for sending, to a backup Unified Data Management (UDM), at least one of the backup radio terminal ID support indication, the backup SUPI and the backup SUCI,
means for sending, to the backup UDM, at least one of the backup radio terminal ID support indication, backup SUPI and Backup SUCI; and
means for receiving, from the backup UDM, subscriber data for a disaster roaming.

### (Supplementary Note 47)

A core network node in a roaming network comprising:
a memory; and
at least one processor configured to access the memory and configured to:
receive, from a terminal, at least one of a backup radio terminal ID, a support indication and a backup International Mobile Subscriber Identity (IMSI),
send, to a backup Home Subscriber Server (HSS), a backup radio terminal ID support indication and the backup IMSI,
receive from the backup HSS, a subscriber data for disaster roaming; and
send, to the radio terminal (UE), a message.

### (Supplementary Note 48)

A method for a core network node in a roaming network comprising:
means for receiving, from a terminal, at least one of a backup radio terminal ID, support indication and a backup International Mobile Subscriber Identity (IMSI),
means for sending, to a backup Home Subscriber Server (HSS), a backup radio terminal ID support indication and the backup IMSI,
means for receiving from the backup HSS, a subscriber data for disaster roaming; and
means for sending, to the radio terminal, a message.
This application is based upon and claims the benefit of priority from Indian patent application No. 202311002701, filed on Jan. 13, 2023, the disclosure of which is incorporated herein in its entirety by reference.

### REFERENCE SIGNS LIST

20 DATA NETWORK
201 IMS
3 UE
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
5 RAN NODE
51 TRANSCEIVER CIRCUIT
52 ANTENNA
53 NETWORK INTERFACE
54 CONTROLLER
55 MEMORY
551 OPERATING SYSTEM
552 COMMUNICATIONS CONTROL MODULE
5521 TRANSCEIVER CONTROL MODULE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
72 UPF
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 AUSF
741 TRANSCEIVER CIRCUIT
742 NETWORK INTERFACE
743 CONTROLLER
744 MEMORY
7441 OPERATING SYSTEM
7442 COMMUNICATIONS CONTROL MODULE
74421 TRANSCEIVER CONTROL MODULE
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NSSF
761 TRANSCEIVER CIRCUIT
762 NETWORK INTERFACE
763 CONTROLLER
764 MEMORY
7641 OPERATING SYSTEM
7642 COMMUNICATIONS CONTROL MODULE
76421 TRANSCEIVER CONTROL MODULE

What is claimed is:

1-22. (canceled)

23. A method for a radio station comprising:
communicating with a User Equipment (UE); and
sending, to the UE, information indicating that the radio station offers service, wherein the UE is located in a disaster condition, wherein the UE is located in a 5G network, wherein the radio station is located in an Long Term Evolution (LTE) network.

24. A method for a User Equipment (UE) comprising:
communicating with a radio station; and
receiving, from the radio station located in an Long Term Evolution (LTE) network, information indicating that the radio station offers service, wherein the UE is located in a disaster condition, wherein the UE is located in a 5G network.

25. A radio station comprising:
a memory; and
at least one processor configured to access the memory and configured to:
communicate with a User Equipment (UE); and
send, to the UE, information indicating that the radio station offers service, wherein the UE is located in a disaster condition, wherein the UE is located in a 5G network, wherein the radio station is located in an Long Term Evolution (LTE) network.

26. A User Equipment (UE) comprising:
a memory; and
at least one processor configured to access the memory and configured to:
communicate with a radio station; and
receive, from the radio station located in an Long Term Evolution (LTE) network, information indicating that the radio station offers service, wherein the UE is located in a disaster condition, wherein the UE is located in a 5G network.
